(19) United States
(12) Patent Application Publication
(10) Pub. No.: US 2014/0077595 A1
(43) Pub. Date: Mar. 20, 2014

(54) BATTERY ENERGY STORAGE SYSTEM

(71) Applicants: Hiromu Kakuya, Tokyo (JP); Motoo Futami, Tokyo (JP)

(72) Inventors: Hiromu Kakuya, Tokyo (JP); Motoo Futami, Tokyo (JP)

(73) Assignee: HITACHI, LTD, CHIYOD-KU (JP)

(21) Appl. No.: 14/119,988

(22) PCT Filed: May 21, 2012
(86) PCT No.: PCT/JP2012/062944

§ 371 Date: Nov. 25, 2013

(30) Foreign Application Priority Data
Jun. 1, 2011 (JP) 2011-123028

(51) Int. Cl. H02J 1/10

(52) U.S. Cl. CPC H02J 1/10
USPC 307/24

(57) ABSTRACT

A battery energy storage system including: a power control circuit group provided by electrically connecting a plurality of power control circuits in series with each other on a load connection terminal side, the plurality of power control circuits each having load connection terminals electrically connected with a load and having power supply connection terminals electrically connected with a power supply, and controlling power supplied to the load side connection terminals or the power supply side connection terminals and outputting the power from the power supply side connection terminals or the load side connection terminals; an electric energy storage device including a plurality of capacitors, a control device for controlling operation of the plurality of power control circuits; and a power usage rate changing section provided so as to correspond to each of the plurality of power control circuits.

### TECHNICAL FIELD

The present invention relates to a battery energy storage system.

### BACKGROUND ART

There are techniques disclosed in Patent Documents 1 and 2, for example, as background art relating to the technical field.

Patent Document 1 discloses a multiplexing inverter device formed by connecting a plurality of power supply circuits in series with each other, and connected to a power system via a transformer. The power supply circuits include a plurality of switch circuits and direct-current power supplies (batteries such as lead batteries) connected to the plurality of switch circuits to output direct-current voltage to the corresponding switch circuits.

Patent Document 2 discloses a battery device in which a plurality of batteries and an auxiliary battery are connected in series with each other in a battery input-output line, and a battery switching control part disconnects a battery judged by a battery diagnosis part to have an abnormality from the battery input-output line, and connects the auxiliary battery to the battery input-output line.

### PRIOR ART DOCUMENT

### Patent Document

Patent Document 1: JP-2006-174663-A
Patent Document 2: JP-2009-213248-A

### SUMMARY OF THE INVENTION

### Problem to be Solved by the Invention

There have recently been concerned about global warming caused by emissions of carbon dioxide and exhaustion of fossil fuels, and thus reductions in amounts of emission of carbon dioxide and decrease in dependence on fossil fuels have been desired. To achieve reductions in amounts of emission of carbon dioxide and decrease in dependence on fossil fuels, driving systems may be converted to electric operation, and the introduction of power generation systems utilizing renewable energy obtained from the nature such as wind power and solar light, for example, may be promoted. In converting the driving systems to electric operation, the driving systems need to include a battery energy storage system that can accumulate and release electric energy as a power supply for driving. In introducing a power generation system utilizing renewable energy, a battery energy storage system that can accumulate and release electric energy needs to be provided along with the power generation system, to suppress the change in power due to variations in renewable energy that is affected by weather conditions, that is, to store excess power when power is in excess and to compensate for a shortage of power when power is in short supply. Thus, in both the systems, battery energy storage systems are indispensable.

There has been an increasing social demand to further restrain global warming and further promote energy savings, for example, in the past few years. To meet this demand necessitates a further reduction in environmental load on the global environment, a further improvement in system efficiency and energy efficiency, and the like. To meet the demand in a battery energy storage system necessitates further improvement in performance. As means for achieving this, as in the technique disclosed in Patent Document 1, a storage system of a multiplexing inverter type may be adopted which storage system is formed by connecting a plurality of power supply circuits in series with each other, each power supply circuit being formed by connecting a switch circuit (AC/DC Converter) and a direct-current power supply (a capacitor), and which storage system is configured to combine the output voltages of the plurality of power supply circuits with each other and output the result. According to the storage system of the multiplexing inverter type, efficiency of power conversion can be increased, and performance can be improved by effective use and effective recovery of electric energy.

Incidentally, the multiplexing inverter type may be referred to as a CMC (Cascade Multilevel Converter) type.

A battery energy storage system has a plurality of capacitors, the number of which differs depending on a system in which the storage system is installed and the like. The states, such for example as power storage performance and life, of the plurality of capacitors change depending on the operation of the storage system. At this time, changes in the states of the plurality of capacitors vary. This is because there are individual differences between the plurality of capacitors. The individual differences between the plurality of capacitors become larger with the passage of time. Therefore the variations in changes in the states of the plurality of capacitors also become larger. The storage system is designed and controlled in consideration of the variations in changes in the states of the plurality of capacitors. However, when the variations in changes in the states of the plurality of capacitors exceed an allowable range, the variations in changes in the states of the plurality of capacitors affect the performance of the storage system. In such a case, the variations in changes in the states of the plurality of capacitors need to be reduced by replacing a capacitor whose state change is greater than the other capacitors with a new capacitor before the variations in changes in the states of the plurality of capacitors exceed the allowable range. In addition, the plurality of capacitors may include a capacitor whose amount of self-discharge with respect to an amount of stored power is larger than the other capacitors. Also in such a case, the capacitor whose amount of self-discharge with respect to the amount of stored power is larger needs to be replaced with a new capacitor.

A method for replacing a capacitor may be to replace the capacitor to be replaced in a state in which a capacitor group including a plurality of capacitors and an auxiliary capacitor are connected to each other, as in the technique disclosed in Patent Document 2. According to such a replacing method, a maximum output required of the battery energy storage system can be ensured without the storage system being stopped even during the work of capacitor replacement. Thus, the operation of the storage system is not limited, and a user of the storage system is not affected by the limitation.

However, according to the replacing method disclosed in Patent Document 2, the provision of the auxiliary capacitor results in a corresponding increase in the cost of the battery energy storage system. In addition, the technique disclosed in Patent Document 2 is a technique for ensuring the maximum capacity of output of the capacitors, and is therefore not applicable as it is for a system that outputs alternating-current power with batteries divided for each inverter as in Patent Document 1.

In addition, the replacement of capacitors does not take into consideration in the technique disclosed in Patent Document 1. To replace a capacitor in the technique disclosed in Patent Document 1, a switch circuit provided so as to correspond to a direct-current power supply including a capacitor to be replaced may be turned off to produce a state in which power is not supplied or received between the power supply circuit and the side of the transformer, and the capacitor may be replaced. However, such a method decreases the maximum input/output of the system, and thus cannot deal with an unexpected command to increase the input/output of the system.

Further, Patent Document 2 may be applied to Patent Document 1, such that the battery energy storage system of the multiplexing inverter type in Patent Document 1 is provided with an auxiliary power supply circuit pair formed by a pair of a switch circuit and a capacitor as in the technique disclosed in Patent Document 2, the auxiliary power supply circuit is connected at a time of replacement of a capacitor, and the capacitor is replaced with a state in which the maximum output of the system is ensured. However, such a method requires an additional cost for the installation of the auxiliary power supply circuit.

### Means for Solving the Problem

A representative problem to be solved by the present application is to provide a battery energy storage system that allows a capacitor to be replaced without the system being stopped.

In providing the above storage system, it is desirable to be able to replace the capacitor without adding an auxiliary device for use in replacement of a capacitor.

In addition, in providing the above storage system, it is desirable to be able to increase the efficiency of the storage system.

Incidentally, other problems will be replaced with effects as the reverse of the problems, and the effects will be described together with means for solving the problems, in embodiments to be described below.

The present application has a plurality of solving means for solving the above representative problem. One of the solving means will be cited as a representative solving means in the following.

According to an aspect of the present invention, there is provided a battery energy storage system including: a power control circuit group formed by electrically connecting a plurality of power control circuits in series with each other on a load connection terminal side, the plurality of power control circuits each having load connection terminals electrically connected with a load and having power supply connection terminals electrically connected with a power supply, and controlling power supplied to the load side connection terminals or the power supply side connection terminals and outputting the power from the power supply side connection terminals or the load side connection terminals; an electric energy storage device including a plurality of capacitors, the electric energy storage device being provided so as to correspond to each of the plurality of power control circuits and electrically connected as the power supply to the power supply connection terminals of the corresponding power control circuit; a control device for controlling operation of the plurality of power control circuits; and a power usage rate changing section provided so as to correspond to each of the plurality of power control circuits, and provided for, when a ratio of an amount of power that each of the power control circuits contributes to an amount of input-output power of the power control circuit group in a predetermined period to a total amount of power in the predetermined period, the total amount of power in the predetermined period being transferred between the load connection terminals and the power supply connection terminals of the plurality of power control circuits, is defined as a power usage rate, changing the ratio of the power usage rate of the corresponding power control circuit. When the ratio of the power usage rate of the corresponding power control circuit needs to be changed, the power usage rate changing means makes the absolute value of the ratio of the power usage rate of the corresponding power control circuit smaller than before the changing is performed, with zero set as a target.

### Effect of the Invention

According to the representative solving means of the present application, it is possible to provide a battery energy storage system that allows a capacitor to be replaced without the system being stopped.

### BRIEF DESCRIPTION OF THE DRAWINGS

FIG. 1 is a system block diagram showing a general configuration of the whole of a battery energy storage system.

FIG. 2 is a circuit diagram showing a configuration of a connected pair of an electric energy storage device and a power converter which connected pair forms the system of FIG. 1.

FIG. 3 is a functional block diagram showing a configuration of a control device of the power converter in FIG. 2.

FIG. 4 is a functional block diagram showing a configuration of a central control device forming the system of FIG. 1.

FIG. 5 is a diagram of assistance in explaining the operation of the system of FIG. 1, and is a circuit diagram showing a configuration of a connected pair of an electric energy storage device and a power converter.

FIG. 6 is a diagram of assistance in explaining the operation of the system of FIG. 1, and is a relation diagram showing relation (in one cycle) between the voltage of an alternating-current power supply system, the target voltage of the battery energy storage system, and a current flowing between a transformer and the storage system.

FIG. 7 is a diagram of assistance in explaining the operation of the system of FIG. 1, and is a relation diagram showing relation (in one cycle) between the voltage at the load side connection terminals of the battery energy storage system as compared with the target voltage shown in FIG. 6 and voltages at the alternating-current terminals of respective power converters.

FIG. 8 is a diagram of assistance in explaining the operation of the system of FIG. 1, and is a relation diagram showing relation (in one cycle) between currents flowing through the alternating-current terminals of the respective power converters.

FIG. 9 is a diagram of assistance in explaining the operation of the system of FIG. 1, and is a relation diagram showing relation (in one cycle) between powers at the alternating-current terminals of the respective power converters.

FIG. 10 is a diagram of assistance in explaining the operation of the system of FIG. 1, and is a relation diagram showing the relation between voltage patterns before and after the absolute value of the power usage rate of a particular power converter is changed.

FIG. 11 is a diagram of assistance in explaining the operation of the system of FIG. 1, and is a relation diagram showing relation (in one cycle) between the voltage at the load side connection terminals of the battery energy storage system as compared with the target voltage shown in FIG. 6 and the voltages at the alternating-current terminals of the respective power converters when the voltage pattern of a particular power converter changes to the voltage pattern shown in FIG. 10.

FIG. 12 is a diagram of assistance in explaining the operation of the system of FIG. 1, and is a relation diagram showing relation (in one cycle) between the currents at the alternating-current terminals of the respective power converters when the voltage pattern of a particular power converter changes to the voltage pattern shown in FIG. 10.

FIG. 13 is a diagram of assistance in explaining the operation of the system of FIG. 1, and is a relation diagram showing relation (in one cycle) between the powers at the alternating-current terminals of the respective power converters when the voltage pattern of a particular power converter changes to the voltage pattern shown in FIG. 10.

FIG. 14 is a diagram of assistance in explaining the operation of the system of FIG. 1, and is a relation diagram showing relation (in one cycle) between the voltage at the load side connection terminals of the battery energy storage system as compared with the target voltage shown in FIG. 6 and the voltages at the alternating-current terminals of the respective power converters when the absolute value of the power usage rate of a particular power converter is changed by making the voltage pattern of the particular power converter a voltage pattern different from the voltage pattern shown in FIG. 10.

FIG. 15 is a diagram of assistance in explaining the operation of the system of FIG. 1, and is a relation diagram showing relation (in one cycle) between the currents at the alternating-current terminals of the respective power converters when the absolute value of the power usage rate of a particular power converter is changed by making the voltage pattern of the particular power converter the voltage pattern different from the voltage pattern shown in FIG. 10.

FIG. 16 is a diagram of assistance in explaining the operation of the system of FIG. 1, and is a relation diagram showing relation (in one cycle) between the powers at the alternating-current terminals of the respective power converters when the absolute value of the power usage rate of a particular power converter is changed by making the voltage pattern of the particular power converter the voltage pattern different from the voltage pattern shown in FIG. 10.

FIG. 17 is a diagram of assistance in explaining operation when a storage battery is replaced from the state shown in FIG. 5, and is a circuit diagram showing a configuration of a connected pair of an electric energy storage device and a power converter.

FIG. 18 is a diagram of assistance in explaining operation when a storage battery is replaced from the state shown in FIG. 5, and is a circuit diagram showing a configuration of a connected pair of an electric energy storage device and a power converter.

FIG. 19 is a diagram of assistance in explaining operation when a storage battery is replaced from the state shown in FIG. 5, and is a circuit diagram showing a configuration of a connected pair of an electric energy storage device and a power converter.

FIG. 20 is a diagram of assistance in explaining operation when a storage battery is replaced from the state shown in FIG. 5, and is a circuit diagram showing a configuration of a connected pair of an electric energy storage device and a power converter.

FIG. 21 is a diagram of assistance in explaining operation when a storage battery is replaced as shown in FIG. 17, and is a flowchart illustrating a procedure when the absolute value of the power usage rate of a particular power converter is changed and the storage battery is replaced.

FIG. 22 is a diagram of assistance in explaining operation when a storage battery is replaced as shown in FIG. 17, and is a flowchart illustrating a procedure when the absolute value of the power usage rate of a particular power converter is changed and the storage battery is replaced.

FIG. 23 is a diagram of assistance in explaining operation when a storage battery is replaced as shown in FIG. 17, and is a timing diagram showing temporal changes in operation and state of each constituent element and temporal changes in signals and electrical characteristics when the absolute value of the power usage rate of a particular power converter is changed and the storage battery is replaced.

FIG. 24 is a diagram of assistance in explaining operation when a storage battery is replaced as shown in FIG. 18, and is a flowchart illustrating a procedure when the absolute value of the power usage rate of a particular power converter is changed and the storage battery is replaced.

FIG. 25 is a diagram of assistance in explaining operation when a storage battery is replaced as shown in FIG. 18, and is a flowchart illustrating a procedure when the absolute value of the power usage rate of a particular power converter is changed and the storage battery is replaced.

FIG. 26 is a diagram of assistance in explaining operation when a storage battery is replaced as shown in FIG. 18, and is a timing diagram showing temporal changes in operation and state of each constituent element and temporal changes in signals and electrical characteristics when the absolute value of the power usage rate of a particular power converter is changed and the storage battery is replaced.

FIG. 27 is a diagram of assistance in explaining operation when a storage battery is replaced as shown in FIG. 19, and is a flowchart illustrating a procedure when the absolute value of the power usage rate of a particular power converter is changed and the storage battery is replaced.

FIG. 28 is a diagram of assistance in explaining operation when a storage battery is replaced as shown in FIG. 19, and is a flowchart illustrating a procedure when the absolute value of the power usage rate of a particular power converter is changed and the storage battery is replaced.

FIG. 29 is a diagram of assistance in explaining operation when a storage battery is replaced as shown in FIG. 19, and is a timing diagram showing temporal changes in operation and state of each constituent element and temporal changes in signals and electrical characteristics when the absolute value of the power usage rate of a particular power converter is changed and the storage battery is replaced.

FIG. 30 is a diagram of assistance in explaining operation when a storage battery is replaced as shown in FIG. 20, and is a flowchart illustrating a procedure when the absolute value of the power usage rate of a particular power converter is changed and the storage battery is replaced.

FIG. 31 is a diagram of assistance in explaining operation when a storage battery is replaced as shown in FIG. 20, and is a flowchart illustrating a procedure when the absolute value of the power usage rate of a particular power converter is changed and the storage battery is replaced.

FIG. 32 is a diagram of assistance in explaining operation when a storage battery is replaced as shown in FIG. 20, and is a timing diagram showing temporal changes in operation and state of each constituent element and temporal changes in signals and electrical characteristics when the absolute value of the power usage rate of a particular power converter is changed and the storage battery is replaced.

FIG. 33 is a perspective view of an actual hardware configuration of the battery energy storage system of FIG. 1.

FIG. 34 is a perspective view of an actual hardware configuration when bypass circuits are added to the battery energy storage system of FIG. 1.

FIG. 35 is a circuit diagram showing a configuration of a bypass circuit in FIG. 34.

FIG. 36 is a perspective view of a hardware configuration when a part of the hardware configuration of FIG. 33 is changed.

FIG. 37 is a perspective view of a hardware configuration when a part of the hardware configuration of FIG. 34 is changed.

### MODE FOR CARRYING OUT THE INVENTION

An embodiment of the present invention will be described.

<Applications to which the Invention is Applied>

In the embodiment to be described in the following, a description will be made by taking as an example a case where the present invention is applied to a stationary storage system installed as a battery energy storage system in a power generation farm together with a power generation system utilizing renewable energy, for example a photovoltaic power generation system or a wind power generation system.

A power generation system utilizing renewable energy has an advantage of imposing a less load on the natural environment. On the other hand, the power generation capacity of the power generation system is affected by the natural environment such as weather, and therefore output from the power generation system to a power system varies. The stationary storage system is provided to suppress (alleviate) the variation of the output from the power generation system. In a case where power output from the power generation system to the power system is in short supply as compared with a predetermined output power, the stationary storage system discharges electricity to compensate for the shortage of the power from the power generation system. In a case where the power output from the power generation system to the power system is in excess as compared with the predetermined power, the stationary storage system receives the excess of the power from the power generation system, and is charged with the excess of the power from the power generation system.

<Other Applications to which the Invention is Applied>

The configuration of the embodiment to be described in the following can be applied also to a stationary storage system installed as an uninterrupted power supply (backup power supply) for a server system in a data center, communication facilities, or the like.

In addition, the configuration of the embodiment to be described in the following can be applied also to a stationary storage system installed as a battery energy storage system that is disposed at the home of a consumer, and which storage system stores power in the nighttime and releases the stored power in the daytime to level power loads.

Further, the configuration of the embodiment to be described in the following can be applied also to a stationary storage system electrically connected to an intermediate point of a transmission and distribution grid, and used as a measure against variation in power transmitted and distributed in the transmission and distribution grid, a measure against excess power, a measure for frequency, a measure against reverse power flows, or the like.

Further, the configuration of the embodiment to be described in the following can be applied also to a mobile storage system installed in a moving body and used as a power supply for driving the moving body, a driving power supply for driving a load mounted on the moving body, or the like. The moving body includes an automobile such as a hybrid electric vehicle using an engine and a motor as driving sources of the vehicle, a purely electric vehicle using a motor as the only driving source of the vehicle, or the like, that is, a land traveling vehicle (a passenger car, a truck, a bus, or the like), a railway vehicle such for example as a hybrid train that generates electric power by the power of a diesel engine and which uses a motor driven by the electric power obtained by the power generation as a driving source, and an industrial vehicle such as a construction machine, a forklift truck, or the like.

### <General Configuration of Battery Energy Storage System>

A battery energy storage system includes a plurality of capacitors (secondary batteries or capacitive passive elements), and accumulates (charges) and releases (discharges) electric energy by the electrochemical action and charge accumulation structure of the plurality of capacitors. The plurality of capacitors are electrically connected in series, in parallel, or in series and parallel with each other according to specifications such as output voltage and power storage capacity required for the storage system.

In the embodiment to be described in the following, a description will be made by taking as an example a case in which a lithium ion secondary battery is used as a capacitor. Another secondary battery such as a lead battery, a nickel metal hydride battery may also be used as a capacitor. Also, two kinds of capacitors, for example a lithium ion secondary battery and a nickel metal hydride battery, may be used in combination with each other. As a capacitive passive element, a capacitor, for example an electric double layer capacitor or a lithium ion capacitor, can be used.

An embodiment of the present invention will hereinafter be described concretely with reference to the drawings.

### <General Configuration of Battery Energy Storage System 1>

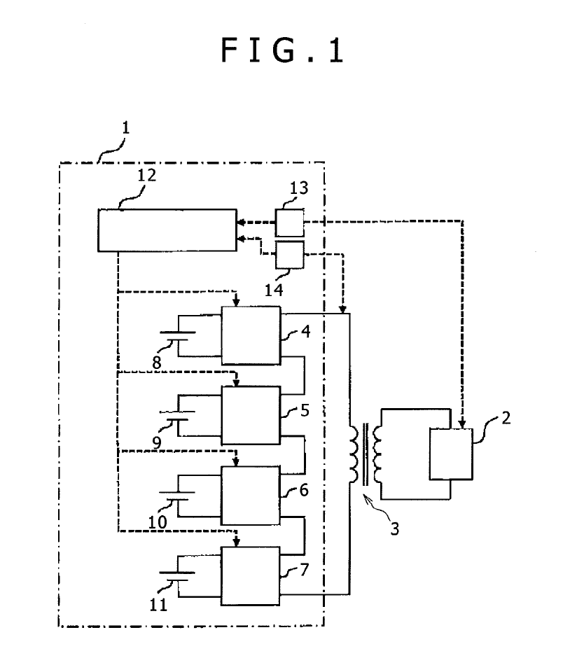

A configuration of a battery energy storage system 1 will first be described with reference to FIGS. 1 to 4.

FIG. 1 shows a general configuration of the whole of the battery energy storage system 1.

Incidentally, while FIG. 1 does not show a power generation system utilizing renewable power, the power generation system is actually connected electrically to an alternating-current power supply system 2.

Load side connection terminals of the battery energy storage system 1 are electrically connected to connection terminals on a primary side or a secondary side of a single-phase transformer 3. Connection terminals of the single-phase transformer 3 which connection terminals are on the opposite side (the secondary side or the primary side) from the battery energy storage system 1 are electrically connected to connection terminals of the single-phase alternating-current power supply system 2. Thus, the battery energy storage system 1 is interconnected with the alternating-current power supply system 2 via the transformer 3, and is able to discharge accumulated electric energy as direct-current power, convert the discharged direct-current power into alternating-current power, and output the alternating-current power to the side of the alternating-current power supply system 2, and to receive alternating-current power supplied from the side of the alternating-current power supply system 2 or the power generation system, convert the received alternating-current power into direct-current power to be charged with the direct-current power, and accumulate the direct-current power as electric energy.

Incidentally, while the present embodiment will be described by taking as an example a case where the alternating-current power supply system 2 is a single-phase alternating-current power supply system, there may be a case where the alternating-current power supply system 2 is a three-phase alternating-current power supply system. In this case, battery energy storage systems 1 for three phases which storage systems are provided so as to correspond to the three respective phases coordinate with the three-phase alternating-current power supply system 2 via a three-phase transformer 3.

The battery energy storage system 1 includes electric energy storage devices 8, 9, 10, and 11, power converters 4, 5, 6, and 7, a central control device 12, a voltage measuring device 13, and a current measuring device 14.

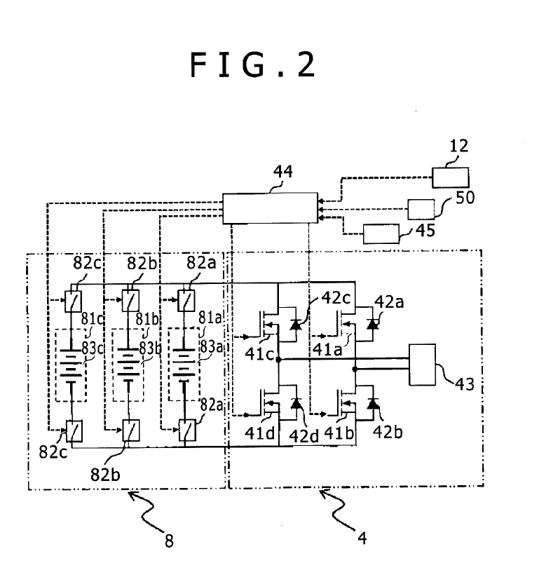

As will be described later with reference to FIG. 2, the electric energy storage devices 8, 9, 10, and 11 each include a plurality of storage batteries (lithium ion secondary batteries) electrically connected in series and parallel with each other. As for the electrical connection of the plurality of storage batteries, one of a series connection, a parallel connection, and a series-parallel connection is used according to specifications relating to output voltage, power storage capacity, and the like required for the storage system. The present embodiment adopts a configuration in which the plurality of storage batteries are electrically connected in series and parallel with each other, because the storage system is provided so as to correspond to the power generation system, and is required to have high voltage and high capacity as specifications.

The power converters 4, 5, 6, and 7 are each provided so as to correspond to one of the electric energy storage devices 8, 9, 10, and 11. The power converters 4, 5, 6, and 7 are power controllers that control power supplied from one of a power supply and a load to a predetermined power and output the predetermined power to the other of the power supply and the load, by for example converting direct-current power output from the corresponding electric energy storage devices 8, 9, 10, and 11 into alternating-current power and outputting the alternating-current power to the transformer 3, or converting alternating-current power supplied from the transformer 3 into direct-current power and outputting the direct-current power to the corresponding electric energy storage devices 8, 9, 10, and 11. As will be described later with reference to FIG. 2, the power converters 4, 5, 6, and 7 include a switching circuit for power control (conversion).

Correspondence relation between the power converters 4, 5, 6, and 7 and the electric energy storage devices 8, 9, 10, and 11 is specifically the relation of connected pairs such that direct-current side connection terminals of the power converter 4 are electrically connected to load side connection terminals of the electric energy storage device 8, direct-current side connection terminals of the power converter 5 are electrically connected to load side connection terminals of the electric energy storage device 9, direct-current side connection terminals of the power converter 6 are electrically connected to load side connection terminals of the electric energy storage device 10, and direct-current side connection terminals of the power converter 7 are electrically connected to load side connection terminals of the electric energy storage device 11.

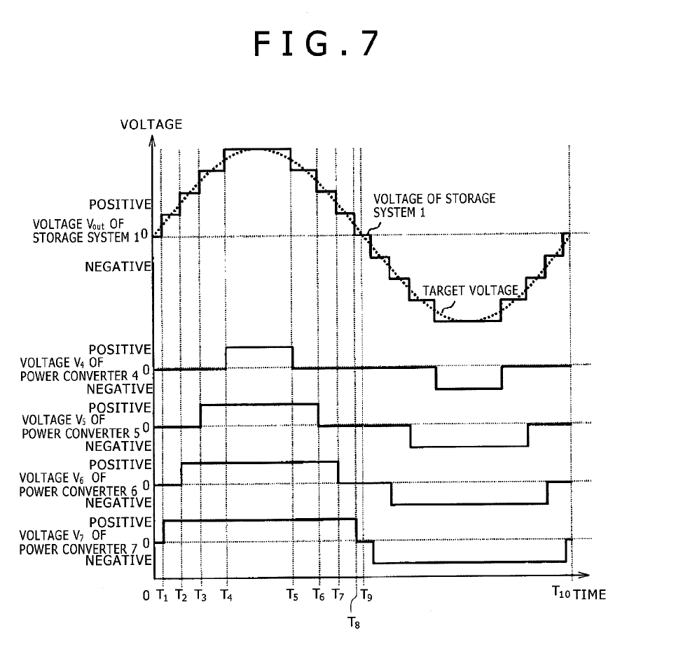

Alternating-current side connection terminals (alternating-current terminals to be described later with reference to FIG. 2) of the power converters 4, 5, 6, and 7 are electrically connected in series with each other. Specifically, one side of the alternating-current side connection terminals of one of two power converters electrically connected in series with each other are electrically connected to another side of the alternating-current side connection terminals of the other of the two power converters, such that another side of the alternating-current side connection terminals of the power converter 4 is electrically connected in series with one side of the alternating-current side connection terminals of the power converter 5, . . . , and another side of the alternating-current side connection terminals of the power converter 6 is electrically connected in series with one side of the alternating-current side connection terminals of the power converter 7. One side of the alternating-current side connection terminals of the power converter 4 and another side of the alternating-current side connection terminals of the power converter 7 are electrically connected to the connection terminals on the primary side or the secondary side of the transformer 3. When the alternating-current side connection terminals of the power converters 4, 5, 6, and 7 are thus electrically connected in series with each other, as will be described with reference to FIG. 7, an output voltage or an input voltage of the load side connection terminals of the battery energy storage system 1 is a composite voltage of output voltages or input voltages of the alternating-current side connection terminals of the power converters 4, 5, 6, and 7.

The central control device 12 controls the operation of the connected pairs of the power converters 4, 5, 6, and 7 and the electric energy storage devices 8, 9, 10, and 11 so that the alternating-current power supply system 2 and the battery energy storage system 1 can supply and receive power in an interconnected state. For this purpose, the central control device 12 receives input information on an alternating voltage of the alternating-current power supply system 2 and input information on an alternating current flowing between the load side connection terminal of the battery energy storage system 1 and the transformer 3, and calculates a command value for controlling the operation of the connected pairs of the power converters 4, 5, 6, and 7 and the electric energy storage devices 8, 9, 10, and 11 according to a control program on the basis of a plurality of pieces of information such as the input information, stored information. Then, the central control device 12 transmits the calculated command value to each of the connected pairs of the power converters 4, 5, 6, and 7 and the electric energy storage devices 8, 9, 10, and 11 by signal transmission using wireless or wired communication. Thereby, in each of the connected pairs of the power converters 4, 5, 6, and 7 and the electric energy storage devices 8, 9, 10, and 11, the operation of the switching circuit is controlled, and electric connection between the switching circuit and the plurality of storage batteries is controlled, so that power transferred between the battery energy storage system 1 and the alternating-current power supply system 2 is controlled so as to coordinate the battery energy storage system 1 and the alternating-current power supply system 2 with each other.

The command value transmitted by signal transmission from the central control device 12 includes a modulated wave (sine wave) indicating a target voltage to be generated at the load side connection terminals of the battery energy storage system 1, a carrier wave (triangular wave) for generating an output voltage or an input voltage in the form of a rectangular wave at the alternating-current side connection terminals of each of the power converters 4, 5, 6, and 7 on the basis of comparison with the modulated wave.

Incidentally, while the present embodiment will be described by taking as an example a case where the modulated wave and the carrier wave are generated in the central control device 12, the carrier wave may be generated in the power converters 4, 5, 6, and 7, and information necessary for the generation, for example information on the potential level of the carrier wave to be generated in each of the power converters 4, 5, 6, and 7, the height of amplitude of the carrier wave to be generated, and the like may be transmitted by signal transmission from the central control device 12.

The voltage measuring device 13 measures the alternating voltage of the alternating-current power supply system 2, and outputs a signal relating to the measured alternating voltage to the central control device 12. The current measuring device 14 measures the alternating current flowing between the load side connection terminal of the battery energy storage system 1 and the transformer 3, and outputs a signal relating to the measured alternating current to the central control device 12.

### <Configuration of Connected Pair of Power Converter and Electric Energy Storage Device>

FIG. 2 shows a configuration of a connected pair of a power converter and an electric energy storage device in the battery energy storage system 1.

Incidentally, the present embodiment has four connected pairs of power converters and electric energy storage devices, as described above, and the pairs each have a same configuration. For this reason, in the present embodiment, the connected pair of the power converter 4 and the electric energy storage device 8 will be cited as a representative, the configuration of the connected pair of the power converter 4 and the electric energy storage device 8 will be described with reference to FIG. 2, and diagrammatic representation and description of the configurations of the other connected pairs will be omitted.

Provided between a direct-current side connection terminals of the power converter 4 and a load side connection terminals of the electric energy storage device 8 is a main circuit that electrically connects the former terminals to the latter terminals. Specifically, the main circuit contains: a direct-current positive electrode side electric path for electrically connecting the positive electrode side of the former terminals to the positive electrode side of latter terminals; and a direct-current negative electrode side electric path for electrically connecting the negative electrode side of the former terminals to the negative electrode side of the latter terminals.

The electric energy storage device 8 includes power storage modules 81a, 81b, and 81c and switches 82a, 82b, and 82c provided so as to correspond to the respective power storage modules 81a, 81b, and 81c.

Positive electrode sides of the power storage modules 81a, 81b, and 81c are electrically connected to each other, and negative electrode sides of the power storage modules 81a, 81b, and 81c are electrically connected to each other. Thereby the power storage modules 81a, 81b, and 81c are electrically connected in parallel with each other. The power storage modules 81a, 81b, and 81c respectively include storage battery groups formed by electrically connecting a plurality of storage batteries 83a, 83b, and 83c in series with one another, the plurality of storage batteries 83a, 83b, and 83c being provided so as to correspond to the power storage modules 81a, 81b, and 81c, respectively.

The switches 82a, 82b, and 82c are connection terminals that control electric connection between the corresponding power storage modules 81a, 81b, and 81c and the main circuit. The switches 82a, 82b, and 82c are formed by a switching device, for example a MOSFET (Metal Oxide Semiconductor Field Effect Transistor).

Incidentally, while the present embodiment will be described by taking as an example a case where a switching device is used as the switches 82a, 82b, and 82c, a mechanical switch mechanism that brings two contacts into contact with each other and separates the two contacts from each other by electromagnetic force may be used.

Correspondence relation between the power storage modules 81a, 81b, and 81c and the switches 82a, 82b, and 82c is specifically the relation of connected pairs such that the switches 82a are electrically connected to the positive electrode side and the negative electrode side of the power storage module 81a, the switches 82b are electrically connected to the positive electrode side and the negative electrode side of the power storage module 81b, and the switches 82c are electrically connected to the positive electrode side and the negative electrode side of the power storage module 81c.

Incidentally, while the present embodiment will be described by taking as an example a case where three power storage modules are provided, the number of power storage modules electrically connected in parallel with each other may be changed according to a rated output voltage, a rated power storage capacity, and the like required for the battery energy storage system 1.

The power converter 4 includes a switching circuit and alternating-current terminals 43 electrically connected to the switching circuit.

The switching circuit includes switching devices 41a, 41b, 41c, and 41d as MOSFETs (Metal Oxide Semiconductor Field Effect Transistors).

Incidentally, while the present embodiment will be described by taking as an example a case where a MOSFET is used as the switching devices 41a, 41b, 41c, and 41d, another switching device such as an IGBT (Insulated-Gate Bipolar Transistor) may be used.

The switching circuit is specifically a single-phase full-bridge inverter circuit including a first arm and a second arm. The first arm is formed by electrically connecting a source of the switching device 41a of an upper arm in series with a drain of the switching device 41b of a lower arm, and the second arm is formed by electrically connecting a source of the switching device 41c of the upper arm in series with a drain of the switching device 41d of the lower arm. These first and second arms are electrically connected in parallel with each other with drains of the switching devices 41a and 41c of the upper arm electrically connected to each other and with sources of the switching devices 41b and 41d of the lower arm electrically connected to each other.

Parasitic diodes are provided between the drains and the sources of the respective switching devices 41a, 41b, 41c, and 41d, due to the structure of the MOSFETs. Specifically, a diode 42a is provided between the drain and the source of the switching device 41a; a diode 42b is provided between the drain and the source of the switching device 41b; a diode 42c is provided between the drain and the source of the switching device 41c; and a diode 42d is provided between the drain and the source of the switching device 41d, respectively. This eliminates a need to provide a separate diode between the drains and the sources of the switching devices. When an IGBT is used as the switching devices, a diode needs to be provided between the drains and the sources of the switching devices.

The drains of the switching devices 41a and 41c of the upper arm are electrically connected as a direct-current positive electrode side connection terminal to the switches 82a, 82b, and 82c provided on the positive electrode side of the power storage modules 81a, 81b, and 81c. The sources of the switching devices 41b and 41d of the lower arm are electrically connected as a direct-current negative electrode side connection terminal to the switches 82a, 82b, and 82c provided on the negative electrode side of the power storage modules 81a, 81b, and 81c. Each of the power storage modules 81a, 81b, and 81c is electrically connected to the first arm and the second arm, or electrically disconnected from the first arm and the second arm, by switching (on or off) the switching devices forming the switches 82a, 82b, and 82c.

A midpoint of the first arm, that is, a point of electric connection between the source of the switching device 41a of the upper arm and the drain of the switching device 41b of the lower arm is tapped as an alternating-current side connection terminal (load side connection terminal), and a midpoint of the second arm, that is, a point of electric connection between the source of the switching device 41c of the upper arm and the drain of the switching device 41d of the lower arm is tapped as an alternating-current side connection terminal (load side connection terminal). Alternating-current terminals 43 are provided to the ends of the respective alternating-current side connection terminals (load side connection terminals) of the first arm and the second arm. Of the two alternating-current terminals 43, one alternating-current terminal 43 is electrically connected to the connection terminal on the primary side or the secondary side of the transformer 3. The other alternating-current terminal 43 is electrically connected to one of the alternating-current terminals of the power converter 5 electrically connected in series with the power converter 4.

In addition, the power converter 4 includes a control device 44 and a signal device 45.

The control device 44 controls the driving of the switching devices 41a, 41b, 41c, and 41d and the switching devices forming the switches 82a, 82b, and 82c so that the target voltage corresponding to the command value transmitted by signal transmission from the central control device 12 is generated at the load side connection terminals of the battery energy storage system 1. For this purpose, the control device 44 receives the command values transmitted by signal transmission from the central control device 12 and the signal device 45 and a plurality of pieces of input information including external information transmitted by signal transmission from an external device 50, and calculates a driving pattern for switching (on and off) the switching devices 41a, 41b, 41c, and 41d and a driving pattern for switching (on and off) the switching devices forming the switches 82a, 82b, and 82c according to a control program on the basis of the plurality of pieces of input information, stored information stored in advance, and the like. Then, the control device 44 generates a driving signal relating to the calculated driving patterns, and outputs the driving signal to gates of the switching devices 41a, 41b, 41c, and 41d and gates of the switching devices forming the switches 82a, 82b, and 82c, thereby controlling the driving of the switching devices 41a, 41b, 41c, and 41d and the switching devices forming the switches 82a, 82b, and 82c.

Though not shown concretely, the signal device 45 is a communicating device that transmits a command value for controlling the switching (on and off) of the switching devices 41a, 41b, 41c, and 41d and a command value for controlling the switching (on and off) of the switching devices forming the switches 82a, 82b, and 82c to the control device 44 by signal transmission when an operator manually operates a button or a lever, for example. The signal device 45 is provided to an external operating device. Communication between the signal device 45 and the control device 44 is performed on a wireless basis or on a wired basis.

Though not shown concretely, the external device 50 is a control device for the power generation system electrically connected with the battery energy storage system 1 or a monitoring device for monitoring a system state, or a maintenance device used to maintain the battery energy storage system 1. Communication between the external device 50 and the control device 44 is performed on a wireless basis or on a wired basis.

### <Configuration of Control Device 44>

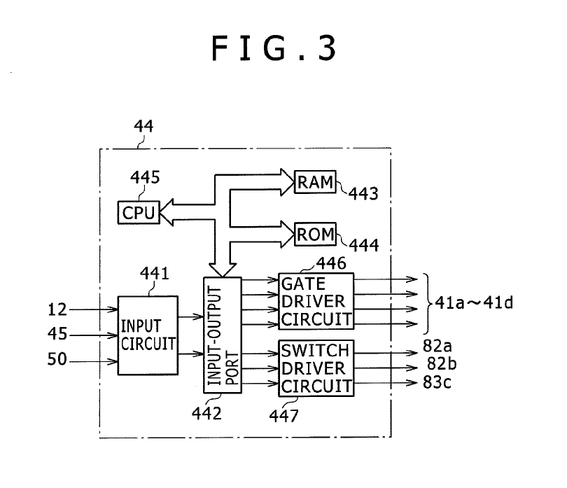

FIG. 3 shows a configuration of the control device 44.

The control device 44 includes an input circuit 441, an input-output port 442, a RAM 443, a ROM 444, a CPU 445, a gate driver circuit 446, and a switch driver circuit 447.

The input circuit 441 is a signal processing circuit that receives the input signals relating to the command values output from the central control device 12 and the signal device 45 and the input signal relating to the external information transmitted by signal transmission from the external device 50 of the battery energy storage system 1, and which processes the input signals so that the control device 44 can operate on the basis of the input signals. When the signals are transmitted by wireless communication between the central control device 12 and the control device 44, for example, the input circuit 441 processes the signals input by radio waves, by for example receiving the radio waves output from the central control device 12 and converting the received radio waves into an electric signal.

The input-output port 442 is an interface circuit provided to enable information to be exchanged between the input circuit 441, the gate driver circuit 446, and the switch driver circuit 447 and the RAM 443, the ROM 444, and the CPU 445, the RAM 443, the ROM 444, and the CPU 445 using a different communication protocol from that of the input circuit 441, the gate driver circuit 446, and the switch driver circuit 447. When information is transmitted by signal transmission from the input circuit 441 to the RAM 443 and the CPU 445, for example, the input-output port 442 receives the input information transmitted by signal transmission from the input circuit 441 according to a first communication protocol, and outputs the input data to each of the RAM 443 and the CPU 445 by signal transmission according to a second communication protocol.

The RAM 443 is an electric energy storage device in which information can be written and read freely, that is, a volatile memory that can retain information when supplied with power and which loses the retained information when the supply of the power is stopped. RAM is an abbreviation for Random Access Memory. Information transmitted by signal transmission to the CPU 445 and information transmitted by signal transmission from the CPU 445 is written to the RAM 443 and retained by the RAM 443.

The ROM 444 is an electric energy storage device in which only the reading of data written in advance and retained therein can be performed, that is, a nonvolatile memory that can retain the data even when not supplied with power. ROM is an abbreviation for Read Only Memory. A control program for the CPU 445 is retained in the ROM 444.

The CPU 445 is an arithmetic unit that reads the control program written in advance and retained in the ROM 444 from the ROM 444, and which calculates a driving pattern for switching (on and off) the switching devices 41a, 41b, 41c, and 41d and a driving pattern for switching (on and off) the switching devices forming the switches 82a, 82b, and 82c according to the read control program on the basis of information transmitted by signal transmission from the input-output port 442 (command value transmitted by signal transmission from the central control device 12) and stored information stored in the RAM 443. CPU is an abbreviation for Central Processing Unit. The driving patterns calculated by the CPU 445 are transmitted by signal transmission to the RAM 443 and retained in the RAM 443, and thereafter transmitted by signal transmission to the gate driver circuit 446 and the switch driver circuit 447 via the input-output port 442.

The gate driver circuit 446 generates a driving signal corresponding to the driving pattern transmitted by signal transmission from the CPU 445 via the input-output port 442, and outputs the driving signal to the gates of the switching devices 41a, 41b, 41c, and 41d. Thereby the switching devices 41a, 41b, 41c, and 41d are driven.

The switch driver circuit 447 generates a driving signal corresponding to the driving pattern transmitted by signal transmission from the CPU 445 via the input-output port 442, and outputs the driving signal to the gates of the switching devices forming the switches 82a, 82b, and 82c. Thereby the switching devices forming the switches 82a, 82b, and 82c are driven.

Incidentally, while the present embodiment has been described by taking as an example a case where the gate driver circuit 446 and the switch driver circuit 447 are provided to the control device 44, the gate driver circuit 446 and the switch driver circuit 447 may be configured separately from the control device 44, that is, configured on a circuit board separate from a circuit board on which electronic parts forming the control device 44 are mounted.

### <Configuration of Central Control Device 12>

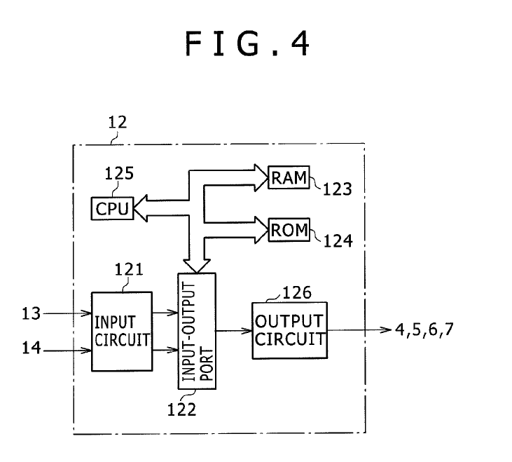

FIG. 4 shows a detailed configuration of the central control device 12.

The central control device 12 includes an input circuit 121, an input-output port 122, a RAM 123, a ROM 124, a CPU 125, and an output circuit 126.

The input circuit 121 is a signal processing circuit that receives an input signal relating to measurement information output from the voltage measuring device 13 and the current measuring device 14, and which subjects the input signal to signal processing, for example converts the input signal from an analog signal to a digital signal, so that the central control device 12 can recognize the input signal.

The input-output port 122 is an interface circuit provided to enable information to be exchanged between the input circuit 121 and the output circuit 126 and the RAM 123, the ROM 124, and the CPU 125, the RAM 123, the ROM 124, and the CPU 125 using a different communication protocol from that of the input circuit 121 and the output circuit 126. When information is to be transmitted by signal transmission from the input circuit 121 to the RAM 123 and the CPU 125, for example, the input-output port 122 receives the input information transmitted by signal transmission from the input circuit 121 according to a first communication protocol, and outputs the input information to each of the RAM 123 and the CPU 125 by signal transmission according to a second communication protocol.

The RAM 123 is an electric energy storage device in which information can be written and read freely, that is, a volatile memory that can retain information when supplied with power and which loses the retained information when the supply of the power is stopped. RAM is an abbreviation for Random Access Memory. Information transmitted by signal transmission to the CPU 125 and information transmitted by signal transmission from the CPU 125 is written to the RAM 123 and retained by the RAM 123.

The ROM 124 is an electric energy storage device in which only the reading of information written in advance and retained therein can be performed, that is, a nonvolatile memory that can retain the information even when not supplied with power. A control program for the CPU 125 is retained in the ROM 124.

The CPU 125 is an arithmetic unit that reads the control program written in advance and retained in the ROM 124 from the ROM 124, and which calculates a command value for each of the connected pairs of the power converters 4, 5, 6, and 7 and the electric energy storage devices 8, 9, 10, and 11 according to the read control program on the basis of information transmitted by signal transmission from the input-output port 122 (measurement information output from the voltage measuring device 13 and the current measuring device 14) and stored information stored in the RAM 123. CPU is an abbreviation for Central Processing Unit. Each command value calculated by the CPU 125 is transmitted by signal transmission to the RAM 123 and retained in the RAM 123, and thereafter transmitted by signal transmission to the output circuit 126 via the input-output port 122.

The output circuit 126 generates a signal relating to each command value transmitted by signal transmission from the CPU 125 via the input-output port 122, and outputs the signal to each of the connected pairs of the power converters 4, 5, 6, and 7 and the electric energy storage devices 8, 9, 10, and 11 (the control device 44 of the power converter 4 and the respective control devices of the power converters 5, 6, and 7). The control device 44 of the power converter 4 and the respective control devices of the power converters 5, 6, and 7 thereby control the operation of the corresponding connected pairs of the power converters 4, 5, 6, and 7 and the electric energy storage devices 8, 9, 10, and 11 on the basis of the command values output from the central control device 12.

### <Description of Operation of Battery Energy Storage System 1 (1)>

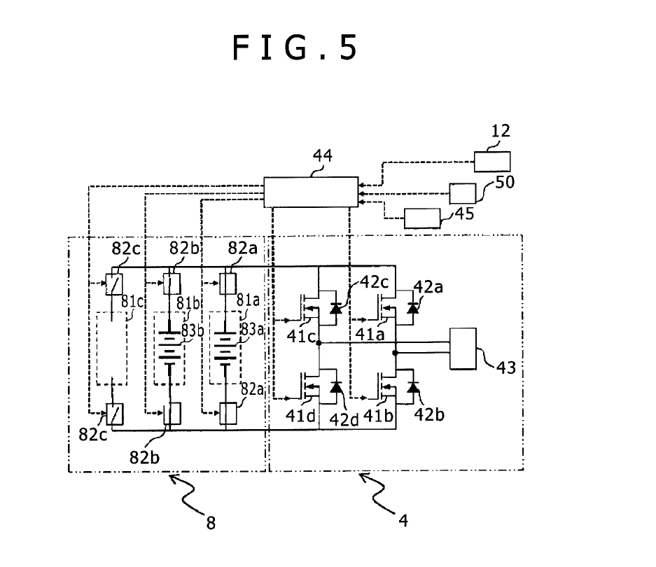

An operation of the battery energy storage system 1 during normal operation will next be described with reference to FIGS. 5 to 9.

In describing the operation, the description will be made by taking as an example a state in which a plurality of storage batteries electrically connected in series with each other are provided in each of two power storage modules in each of the connected pairs of the power converters 4, 5, 6, and 7 and the electric energy storage devices 8, 9, 10, and 11, and the operation is performed with the two power storage modules electrically connected to the corresponding power converter.

In addition, in describing the operation, the description will be made by taking as an example the operation of the connected pair of the power converter 4 and the electric energy storage device 8. As shown in FIG. 5, the connected pair of the power converter 4 and the electric energy storage device 8 is in an operating state in which: the power storage module 81a provided by electrically connecting a plurality of storage batteries 83a in series with each other is electrically connected to the power converter 4 by closing the switches 82a; and the power storage module 81b provided by electrically connecting a plurality of storage batteries 83b in series with each other is electrically connected to the power converter 4 by closing the switches 82b. Also in the other connected pairs, two power storage modules are similarly electrically connected to the power converters 5, 6, and 7 by closing the switches. In addition, the power storage module 81c in this case is treated as an empty power storage module that is provided in expectation of an extension of the battery energy storage system 1 in the future according to conditions on the side of the alternating-current power supply system 2, and which does not have a plurality of storage batteries electrically connected in series with each other.

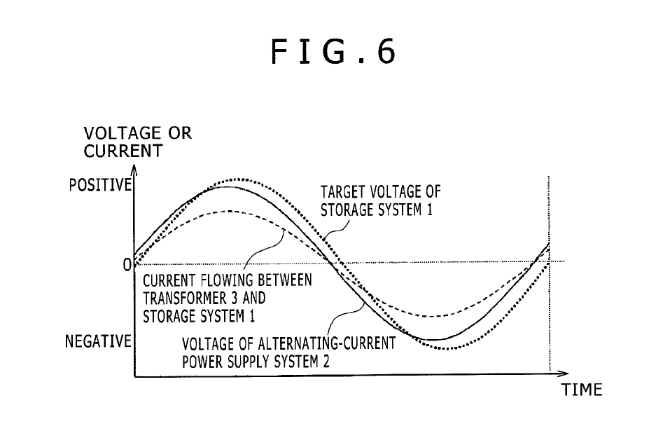

Further, in describing the operation, as shown in FIG. 6, the description will be made by taking as an example a state in which the phase of the target voltage of the battery energy storage system 1 is delayed with respect to the voltage of the alternating-current power supply system 2, a current is flowing from the transformer 3 to the battery energy storage system 1, and the battery energy storage system 1 is receiving alternating-current power from the alternating-current power supply system 2 via the transformer 3.

FIG. 6, in which an axis of ordinates indicates voltage and current (positive and negative) and an axis of abscissas indicates time, shows relation (in one cycle) between the voltage (solid line) of the alternating-current power supply system 2 which voltage is measured by the voltage measuring device 13, the target voltage (dotted line) of the load side connection terminals of the battery energy storage system 1, and the current (broken line) flowing between the transformer 3 and the battery energy storage system 1 which current is measured by the current measuring device 14.

FIG. 7, in which an axis of ordinates indicates voltage (positive and negative) and an axis of abscissas indicates time, shows the relation (in one cycle) between the voltage at the load side connection terminals of the battery energy storage system 1 as compared with the target voltage shown in FIG. 6 and voltages generated at the alternating-current terminals 43 of the power converter 4 and the respective alternating-current terminals of the power converters 5, 6, and 7.

FIG. 7 shows, in order from a top, the voltage Vₒᵤₜ generated at the load side connection terminals of the battery energy storage system 1, the voltage V₄ generated at the alternating-current terminals 43 of the power converter 4, the voltage V₅ generated at the alternating-current terminals of the power converter 5, the voltage V₆ generated at the alternating-current terminals of the power converter 6, and the voltage V₇ generated at the alternating-current terminals of the power converter 7.

In addition, in FIG. 7, a point of intersection of the axis of ordinates and the axis of abscissas is set as a reference 0, an upper side of the reference 0 is set positive, and a lower side of the reference 0 is set negative.

Further, in FIG. 7, a dotted line represents the target voltage of the battery energy storage system 1, that is, the target voltage (modulated wave in the form of a sine wave) of the load side connection terminals of the battery energy storage system 1, which target voltage is calculated in the central control device 12 and transmitted by signal transmission from the central control device 12 to the control device 44 of the power converter 4 and the respective control devices of the power converters 5, 6, and 7.

As shown in FIG. 7, the battery energy storage system 1 controls the switching (on and off) of the switching devices 41a, 41b, 41c, and 41d of the power converter 4 and the four switching devices of each of the power converters 5, 6, and 7 so that voltages in the form of rectangular waves which voltages have different amplitude reference potentials and different widths are generated at the alternating-current terminals 43 of the power converter 4 and the respective alternating-current terminals of the power converters 5, 6, and 7 and thus a voltage corresponding to the target voltage output from the central control device 12 is generated at the load side connection terminals of the battery energy storage system 1, and combines the voltages in the form of the rectangular waves with each other, the voltages in the form of the rectangular waves being thereby generated at the alternating-current terminals 43 of the power converter 4 and the respective alternating-current terminals of the power converters 5, 6, and 7, and the voltages in the form of the rectangular waves having the different amplitude reference potentials and the different widths and having a same amplitude height. A stepwise voltage corresponding to the target voltage is thereby generated at the load side connection terminals of the battery energy storage system 1.

Specifically, in a period from time 0 to time T₉, a positive voltage having the same amplitude height is generated at the alternating-current terminals 43 of the power converter 4 in a period from time T₄ to time T₅, at the alternating-current terminals of the power converter 5 in a period from time T₃ to time T₆, at the alternating-current terminals of the power converter 6 in a period from time T₂ to time T₇, and at the alternating-current terminals 7 of the power converter in a period from time T₁ to time T₈. In addition, in a period from time T₉ to time T₁₀, voltages (negative voltages) that have the same durations (same amplitude widths) and the same amplitude height (absolute value) as the positive voltages generated in the period from time 0 to time T₉, and which have an opposite amplitude direction from the positive voltages are generated symmetrically to the positive voltages. The voltages generated at the alternating-current terminals 43 of the power converter 4 and the respective alternating-current terminals of the power converters 5, 6, and 7 are added together because the alternating-current terminals 43 of the power converter 4 and the respective alternating-current terminals of the power converters 5, 6, and 7 are electrically connected in series with each other. As a result, a stepwise voltage is generated at the load side connection terminals of the battery energy storage system 1.

At this time, the control device 44 of the power converter 4 and the respective control devices of the power converters 5, 6, and 7 calculate a driving pattern for the corresponding four switching devices on the basis of the command value (comparison between a carrier wave and a modulated wave) transmitted by signal transmission from the central control device 12 so that the voltages in the form of the rectangular waves as described above are generated at the alternating-current terminals 43 of the power converter 4 and the respective alternating-current terminals of the power converters 5, 6, and 7. Then, the control device 44 of the power converter 4 and the respective control devices of the power converters 5, 6, and 7 generate a driving signal corresponding to the calculated driving pattern, and output the driving signal to the gates of the corresponding four switching devices to switch (on and off) the corresponding four switching devices.

Here, the absolute values of magnitude (peak values) of the voltages of the power converters 4, 5, 6, and 7 with respect to the reference potentials are substantially equal to the voltages between the connection terminals of the corresponding electric energy storage devices 8, 9, 10, and 11 electrically connected to the respective power converters 4, 5, 6, and 7, the connection terminals of the corresponding electric energy storage devices 8, 9, 10, and 11 being on the side of the power converters 4, 5, 6, and 7.

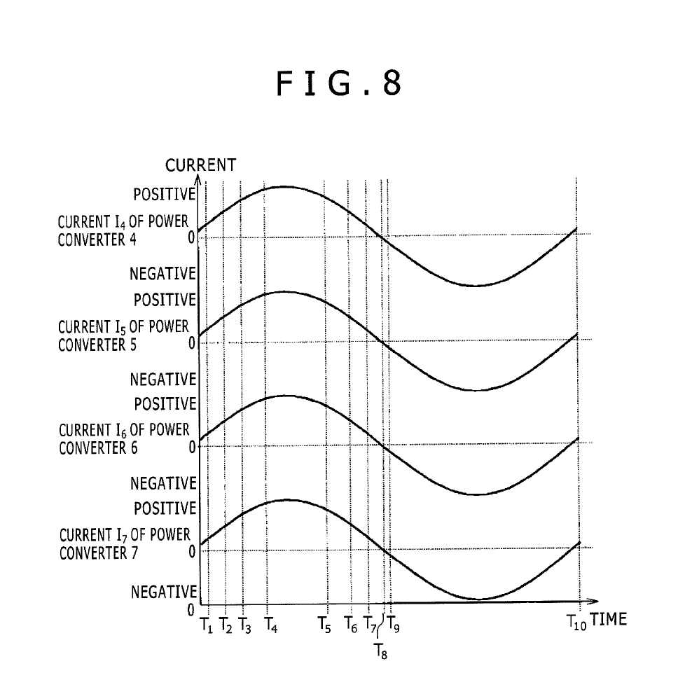

FIG. 8, in which an axis of ordinates indicates current (positive and negative) and an axis of abscissas indicates time, shows relation (in one cycle) between the currents flowing through the alternating-current terminals 43 of the power converter 4 and the respective alternating-current terminals of the power converters 5, 6, and 7.

FIG. 8 shows, in order from a top, the current I₄ flowing through the alternating-current terminals 43 of the power converter 4, the current I₅ flowing through the alternating-current terminals of the power converter 5, the current I₆ flowing through the alternating-current terminals of the power converter 6, and the current I₇ flowing through the alternating-current terminals of the power converter 7.

In addition, in FIG. 8, a point of intersection of the axis of ordinates and the axis of abscissas is set as a reference 0, an upper side of the reference 0 is set positive, and a lower side of the reference 0 is set negative.

As is clear from a comparison between FIG. 6 and FIG. 8, the currents flowing through the alternating-current terminals 43 of the power converter 4 and the respective alternating-current terminals of the power converters 5, 6, and 7 (see FIG. 8) have the same amplitude (width and height) and the same phase as the current flowing between the transformer 3 and the load side connection terminal of the battery energy storage system 1 (see FIG. 6).

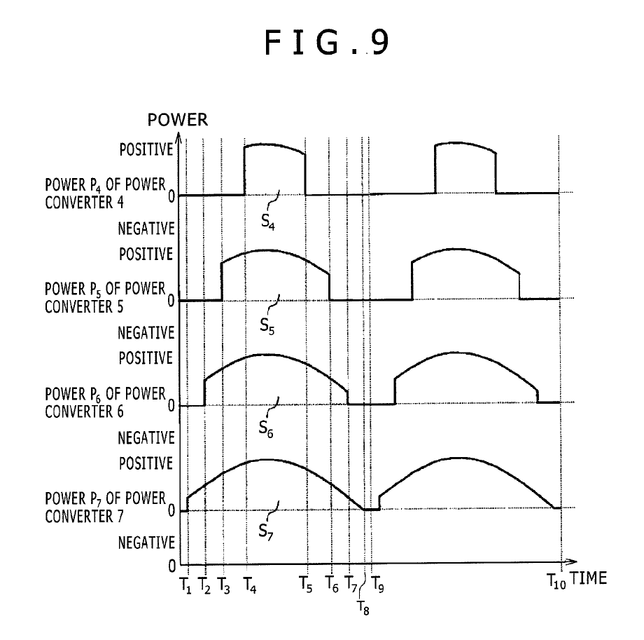

FIG. 9, in which an axis of ordinates indicates power (positive and negative) and an axis of abscissas indicates time, shows the relation (in one cycle) between the powers generated at the alternating-current terminals 43 of the power converter 4 and the respective alternating-current terminals of the power converters 5, 6, and 7.

FIG. 9 shows, in order from a top, the power P₄ generated at the alternating-current terminals 43 of the power converter 4, the power P₅ generated at the alternating-current terminals of the power converter 5, the power P₆ generated at the alternating-current terminals of the power converter 6, and the power P₇ generated at the alternating-current terminals of the power converter 7.

In addition, in FIG. 9, a point of intersection of the axis of ordinates and the axis of abscissas is set as a reference 0, an upper side of the reference 0 is set positive, and a lower side of the reference 0 is set negative.

The powers generated at the alternating-current terminals 43 of the power converter 4 and the respective alternating-current terminals of the power converters 5, 6, and 7 are integrated values of the voltages generated at the alternating-current terminals 43 of the power converter 4 and the respective alternating-current terminals of the power converters 5, 6, and 7 (see FIG. 7) and the currents flowing through the alternating-current terminals 43 of the power converter 4 and the respective alternating-current terminals of the power converters 5, 6, and 7 (see FIG. 8).

Specifically, in the period from time 0 to time T₉, a positive power is generated at the alternating-current terminals 43 of the power converter 4 in the period from time T₄ to time T₅, a positive power is generated at the alternating-current terminals of the power converter 5 in the period from time T₃ to time T₆, a positive power is generated at the alternating-current terminals of the power converter 6 in the period from time T₂ to time T₇, and a positive power is generated at the alternating-current terminals of the power converter 7 in the period from time T₁ to time T₈.

Incidentally, the positive direction of the powers indicates a state in which the battery energy storage system 1 is receiving power from the alternating-current power supply system 2.

In the period from time T₉ to time T₁₀, positive powers that have the same durations (same amplitude widths) and the same amplitude height (absolute value) as the positive powers obtained in the period from time 0 to time T₉, and which have the same amplitude direction as the positive voltages are generated.

In addition, hatched portions shown in FIG. 9 (areas of the portions enclosed by waveforms) represent amounts of power in half a cycle (½ cycle) which amounts of power are generated at the alternating-current terminals 43 of the power converter 4 and the respective alternating-current terminals of the power converters 5, 6, and 7, that is, received by the respective power converters 4, 5, 6, and 7 from the alternating-current power supply system 2 in the above-described respective periods.

Here, when the hatched portions shown in FIG. 9 (areas of the portions enclosed by the waveforms) are defined as S₄, S₅, S₆, and S₇, respectively, the following relation holds between S₄, S₅, S₆, and S₇.

[Expression 1]

S₄<S₅<S₆<S₇ Expression (1)

When the battery energy storage system 1 continues operating with the relation of Expression (1) maintained as it is, variations in power storage state (SOC) between the electric energy storage devices 8, 9, 10, and 11 increase with the passage of time, on the basis of deviations between the amounts of power supplied to the respective electric energy storage devices 8, 9, 10, and 11. To prevent the variations from increasing, each of the voltage patterns generated at the alternating-current terminals 43 of the power converter 4 and the respective alternating-current terminals of the power converters 5, 6, and 7 may be changed.

For example, the voltage patterns generated at the alternating-current terminals 43 of the power converter 4 and the respective alternating-current terminals of the power converters 5, 6, and 7 may be shifted one by one each time a predetermined period has passed so that each of the voltage patterns generated at the alternating-current terminals 43 of the power converter 4 and the respective alternating-current terminals of the power converters 5, 6, and 7 is sequentially changed to the four voltage patterns, by for example changing the voltage pattern generated at the alternating-current terminals 43 of the power converter 4 which voltage pattern is shown in FIG. 7 to the voltage pattern generated at the alternating-current terminals of the power converter 5 which voltage pattern is shown in FIG. 7, changing the voltage pattern generated at the alternating-current terminals of the power converter 5 which voltage pattern is shown in FIG. 7 to the voltage pattern generated at the alternating-current terminals of the power converter 6 which voltage pattern is shown in FIG. 7, . . . , and changing the voltage pattern generated at the alternating-current terminals of the power converter 7 which voltage pattern is shown in FIG. 7 to the voltage pattern generated at the alternating-current terminals of the power converter 4 which voltage pattern is shown in FIG. 7 after the passage of a predetermined period. When such changes are made, total values of the amounts of power input to the respective electric energy storage devices 8, 9, 10, and 11 are the same value in a stage in which the four voltage patterns have been generated at each of the alternating-current terminals 43 of the power converter 4 and the respective alternating-current terminals of the power converters 5, 6, and 7. Thus, the increase in the variations in power storage state (SOC) between the electric energy storage devices 8, 9, 10, and 11 can be suppressed.

Incidentally, while the present embodiment has been described by taking as an example a case where the voltage patterns generated at the alternating-current terminals 43 of the power converter 4 and the respective alternating-current terminals of the power converters 5, 6, and 7 are shifted one by one each time a predetermined period has passed, another shifting method may be adopted as long as the number of times of generation of different voltage patterns at each of the alternating-current terminals 43 of the power converter 4 and the respective alternating-current terminals of the power converters 5, 6, and 7 is equal between the alternating-current terminals 43 of the power converter 4 and the respective alternating-current terminals of the power converters 5, 6, and 7.

### <Description of Operation of Battery Energy Storage System 1 (2)>

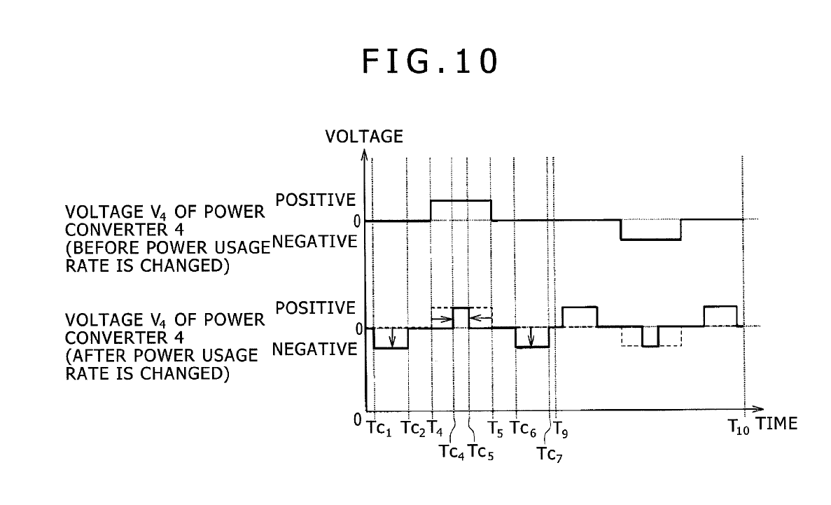

An operation of the battery energy storage system 1 when the absolute value of a power usage rate of a particular power converter is changed from a rate under a predetermined operating condition will next be described with reference to FIGS. 10 to 16.

Here, the predetermined operating condition represents the time of normal operation of the battery energy storage system 1 which operation has been described with reference to FIGS. 5 to 9.

In addition, in the present embodiment, description will be made by taking as an example a case where the particular power converter is the power converter 4.

The power usage rate Pfᵢ of a power converter i is defined by Expression (2).

$$\begin{matrix} [ Expression 2 ] & \\ {Pf}_{t} = \frac{\frac{1}{{T}_{10}} {\int }_{0}^{{T}_{10}} {V}_{t} ( t ) {I}_{t} ( t ) d t}{\sqrt{\frac{1}{{T}_{10}} {\int }_{0}^{{T}_{10}} {\{ {V}_{t} ( t ) \}}^{2} d t} \sqrt{\frac{1}{{T}_{10}} {\int }_{0}^{{T}_{10}} {\{ {I}_{t} ( t ) \}}^{2} d t}} & Expression ( 2 )\end{matrix}$$

where Vᵢ(t) and Iᵢ(t) denote a voltage generated at the alternating-current terminals of the power converter i at time t and a current flowing through the direct-current terminals of the power converter i at time t.

The denominator of Expression (2) represents a total amount of power transferred between the electric energy storage device and the system 2 that are connected to each other via the power converter i. The numerator of Expression (2) represents an amount of power used for the target operation of the battery energy storage system 1, which amount of power is included in the amount of power transferred between the electric energy storage device and the system that are connected to each other via the power converter i. From this, the power usage rate defined by Expression (2) represents a ratio of the amount of power used for the battery energy storage system 1 to the amount of power transferred between the electric energy storage device and the system 2 via the power converter i.

A principle of changing the absolute value of the power usage rate of the power converter will first be described with reference to FIG. 10.

FIG. 10 shows changes in the voltage pattern of the power converter 4 when the absolute value of the power usage rate of the power converter 4 is changed.

In FIG. 10, a voltage pattern before the absolute value of the power usage rate of the power converter 4 is changed is shown in an upper portion, and a voltage pattern after the absolute value of the power usage rate of the power converter 4 is changed is shown in a lower portion.

In addition, in FIG. 10, to facilitate understanding of changes between the voltage patterns before and after the absolute value of the power usage rate of the power converter 4 is changed, the voltage pattern before the absolute value of the power usage rate of the power converter 4 is changed (broken line) is shown superimposed on the voltage pattern after the absolute value of the power usage rate of the power converter 4 is changed (solid line of the voltage pattern in the lower portion).

As shown in FIG. 10, before the absolute value of the power usage rate of the power converter 4 is changed, a positive voltage is generated in a period from time T₄ to time T₅. When the absolute value of the power usage rate of the power converter 4 is changed, the period of generation of the positive voltage is shortened to a period from time Tc₄ later than time T₄ to time Tc₅ earlier than time T₅. In a period from time T₉ to time T₁₀, a negative voltage that has the same duration (same amplitude width) and the same amplitude height (absolute value) as the positive voltage, and which has an opposite amplitude direction from the positive voltage is generated symmetrically to the positive voltage. When the absolute value of the power usage rate of the power converter 4 is changed, the period of generation of the negative voltage is shortened by the same periods (same amplitude widths) as the positive voltage.

In addition, when the absolute value of the power usage rate of the power converter 4 is changed, a negative voltage is generated in a period from time Tc₂ to time Tc₂ and a period from time Tc₆ to time Tc₂ in the period from time 0 to time T₉. In the period from time T₉ to time T₁₀, positive voltages that have the same durations (same amplitude widths) and the same amplitude height (absolute value) as the negative voltages generated in the period from time 0 to time T₉, and which have an opposite amplitude direction from the negative voltages generated in the period from time 0 to time T₉ are generated.

When the period during which the positive (negative) voltage is generated is shortened as compared with the predetermined operating condition as described above, an amount of power received (transmitted) by the alternating-current terminals 43 of the power converter 4 can be decreased, and when the period during which the voltage is made negative (positive) is provided in the period during which the positive (negative) voltage is generated, an amount of power transmitted (received) by the alternating-current terminals 43 of the power converter 4 can be increased. This can make an integrated amount of power during one cycle period substantially zero, and make the absolute value of the power usage rate of the power converter 4 zero. Also in the power converters 5, 6, and 7, the absolute values of the power usage rates of the power converters 5, 6, and 7 can be made to be zero by controlling the voltages on the basis of a similar concept.

Such power usage rate control can be realized in the control device 44 of the power converter 4 by correcting the driving pattern for the corresponding four switching devices, which driving pattern is calculated on the basis of the command value (comparison between a carrier wave and a modulated wave) transmitted by signal transmission from the central control device 12, by a correcting driving pattern for power usage rate control for the corresponding four switching devices, which correcting driving pattern is calculated on the basis of a command value output from the signal device 45 or the external device 50 or a power usage rate command value transmitted by signal transmission from the central control device 12. The correcting driving pattern for power usage rate control is calculated so as to correspond to each of the four voltage patterns generated at the alternating-current terminals 43 of the power converter 4.

Incidentally, the voltage pattern when the absolute value of the power usage rate of the power converter 4 is made to be zero does not need to be symmetric with respect to time T₉/2 as a middle time between time 0 to time T₉.

In addition, when the command value (maximum value of amplitude of the modulated wave) calculated in the central control device 12 is lower than a maximum voltage generated at the load side connection terminals of the battery energy storage system 1, and there are a plurality of connected pairs of power converters and electric energy storage devices which connected pairs do not take part in the generation of the voltage at the load side connection terminals of the battery energy storage system 1, a certain power converter may generate a positive or negative voltage in a period of half a cycle, and another power converter may generate a voltage of different polarity so as to supplement the generation of the positive or negative voltage.

Further, while a voltage pattern that makes a power balance amount zero in half a cycle is used in FIG. 10, a voltage pattern that makes the power balance amount in the whole period of one cycle zero may be used.

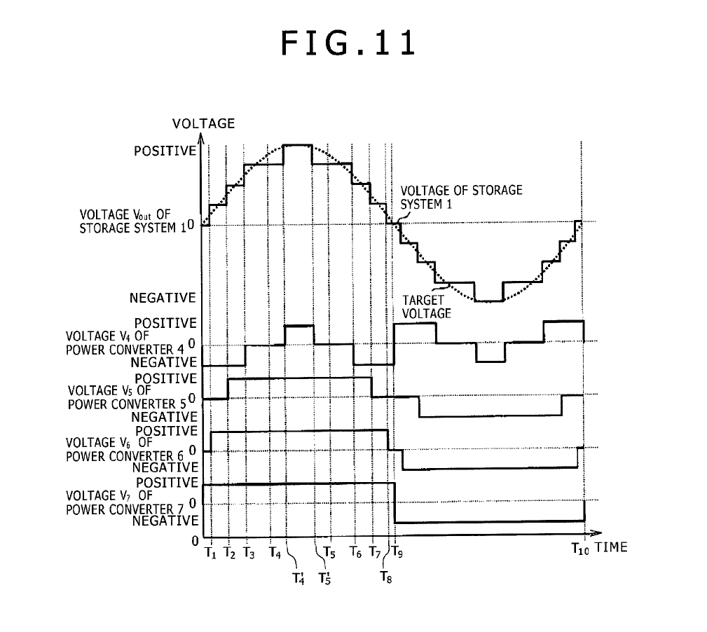

An operation when the absolute value of the power usage rate of the power converter 4 in the battery energy storage system 1 is made to be zero will next be described with reference to FIGS. 11 to 13.

FIG. 11, in which an axis of ordinates indicates voltage (positive and negative) and an axis of abscissas indicates time, shows the relation (in one cycle) between the voltage at the load side connection terminals of the battery energy storage system 1 as compared with the target voltage shown in FIG. 6 and the voltages generated at the alternating-current terminals 43 of the power converter 4 and the respective alternating-current terminals of the power converters 5, 6, and 7.

FIG. 11 shows, in order from a top, the voltage Vₒᵤₜ generated at the load side connection terminals of the battery energy storage system 1, the voltage V₄ generated at the alternating-current terminals 43 of the power converter 4, the voltage V₅ generated at the alternating-current terminals of the power converter 5, the voltage V₆ generated at the alternating-current terminals of the power converter 6, and the voltage V₇ generated at the alternating-current terminals of the power converter 7.

In addition, in FIG. 11, a point of intersection of the axis of ordinates and the axis of abscissas is set as a reference 0, an upper side of the reference 0 is set positive, and a lower side of the reference 0 is set negative.

Further, in FIG. 11, a dotted line represents the target voltage of the battery energy storage system 1, that is, the target voltage (modulated wave in the form of a sine wave) calculated in the central control device 12 and transmitted by signal transmission from the central control device 12 to the control device 44 of the power converter 4 and the respective control devices of the power converters 5, 6, and 7.

As shown in FIG. 11, the voltage pattern generated at the alternating-current terminals 43 of the power converter 4 is different from the voltage pattern shown in FIG. 7. To make the absolute value of the power usage rate of the power converter 4 zero, a negative voltage is generated in a period from time 0 to time T₃ and a period from time T₆ to time T₉, and the period during which the voltage is made positive is shortened to a period from time T′₄ to time T′₅.

Here, when the voltage pattern generated at the alternating-current terminals 43 of the power converter 4 is the voltage pattern shown in FIG. 10 which voltage pattern makes the power usage rate zero, the voltage patterns of the power converters 5, 6, and 7 are the voltage patterns shown in FIG. 7, and the voltages generated at the alternating-current terminals 43 of the power converter 4 and the alternating-current terminals of the power converters 5, 6, and 7 are combined with each other, it is difficult to make the voltage generated at the load side connection terminals of the battery energy storage system 1 the target voltage for the storage system 1, and the amount of power received in the storage system 1 which power is supplied from the alternating-current power supply system 2 to the storage system 1 is reduced.

Therefore, in the present embodiment, the period of the positive voltage generated at the alternating-current terminals of the power converter 5 is extended to a period from time T₁ to time T₇, the period of the positive voltage generated at the alternating-current terminals of the power converter 6 is extended to a period from time T₂ to time T₈, and the period of the positive voltage generated at the alternating-current terminals of the power converter 7 is extended to a period from time 0 to time T₉. This enables the amount of power received by the battery energy storage system 1 from the alternating-current power supply system 2 to be substantially equal to that during the normal operation shown in FIG. 7.

Such voltage generation period extending control can be realized in the respective control devices of the power converters 5, 6, and 7 by correcting the driving pattern for the corresponding four switching devices, which driving pattern is calculated on the basis of the command value (comparison between a carrier wave and a modulated wave) transmitted by signal transmission from the central control device 12, by a correcting driving pattern for voltage generation period extension for the corresponding four switching devices, which correcting driving pattern is calculated on the basis of a command value output from the signal device 45 or the external device 50 or a power usage rate command value transmitted by signal transmission from the central control device 12. The correcting driving pattern for voltage generation period extension is calculated so as to correspond to each of the four voltage patterns generated at the respective alternating-current terminals of the power converters 5, 6, and 7.

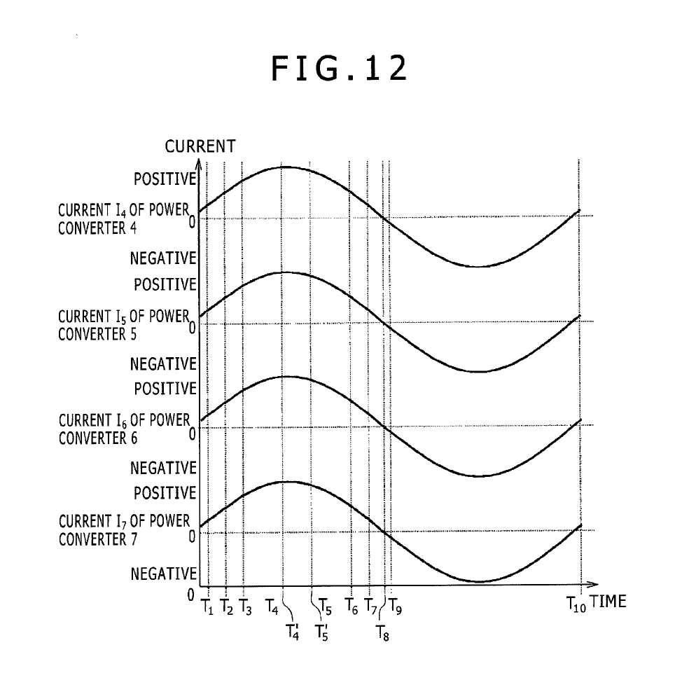

FIG. 12, in which an axis of ordinates indicates current (positive and negative) and an axis of abscissas indicates time, shows relation (in one cycle) between the currents flowing through the alternating-current terminals 43 of the power converter 4 and the respective alternating-current terminals of the power converters 5, 6, and 7.

FIG. 12 shows, in order from a top, the current I₄ flowing through the alternating-current terminals 43 of the power converter 4, the current I₅ flowing through the alternating-current terminals of the power converter 5, the current I₆ flowing through the alternating-current terminals of the power converter 6, and the current I₇ flowing through the alternating-current terminals of the power converter 7.

In addition, in FIG. 12, a point of intersection of the axis of ordinates and the axis of abscissas is set as a reference 0, an upper side of the reference 0 is set positive, and a lower side of the reference 0 is set negative.

As is clear from comparison between FIG. 6 and FIG. 12, the currents flowing through the alternating-current terminals 43 of the power converter 4 and the respective alternating-current terminals of the power converters 5, 6, and 7 (see FIG. 12) have the same amplitude (width and height) and the same phase as the current flowing between the transformer 3 and the load side connection terminal of the battery energy storage system 1 (see FIG. 6).

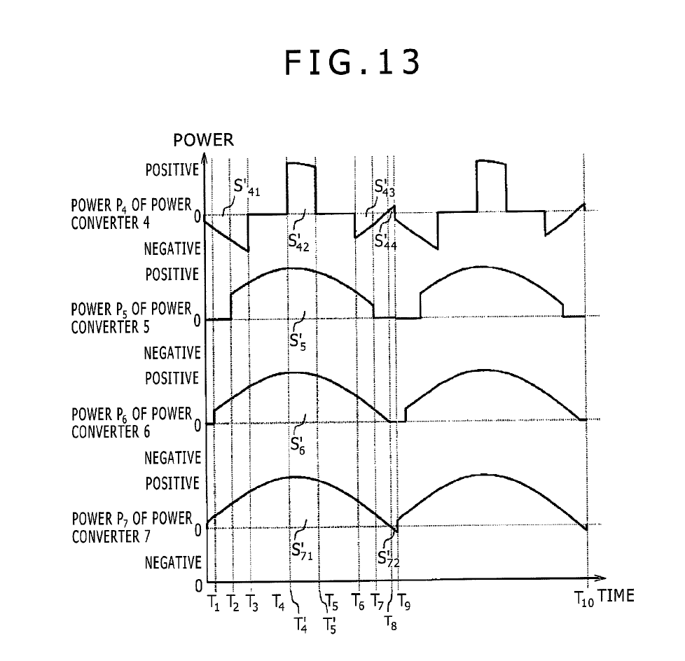

FIG. 13, in which an axis of ordinates indicates power (positive and negative) and an axis of abscissas indicates time, shows relation (in one cycle) between the powers generated at the alternating-current terminals 43 of the power converter 4 and the respective alternating-current terminals of the power converters 5, 6, and 7.

FIG. 13 shows, in order from a top, the power P₄ generated at the alternating-current terminals 43 of the power converter 4, the power P₅ generated at the alternating-current terminals of the power converter 5, the power P₆ generated at the alternating-current terminals of the power converter 6, and the power P₇ generated at the alternating-current terminals of the power converter 7.

In addition, in FIG. 13, a point of intersection of the axis of ordinates and the axis of abscissas is set as a reference 0, an upper side of the reference 0 is set positive, and a lower side of the reference 0 is set negative.

The powers generated at the alternating-current terminals 43 of the power converter 4 and the respective alternating-current terminals of the power converters 5, 6, and 7 are integrated values of the voltages generated at the alternating-current terminals 43 of the power converter 4 and the respective alternating-current terminals of the power converters 5, 6, and 7 (see FIG. 11) and the currents flowing through the alternating-current terminals 43 of the power converter 4 and the respective alternating-current terminals of the power converters 5, 6, and 7 (see FIG. 12).

Specifically, in the period from time 0 to time T₉, a positive power is generated in the period from time T′₄ to time T′₅ at the alternating-current terminals 43 of the power converter 4, and a negative power is generated in the period from time 0 to time T₃ and the period from time T₆ to time T₉ at the alternating-current terminals 43 of the power converter 4.

Incidentally, the positive direction of the powers indicates a state in which the battery energy storage system 1 is receiving power from the alternating-current power supply system 2, and the negative direction of the powers indicates a state in which power is discharged from the storage system 1 to the alternating-current power supply system 2.

Here, when integrated amounts of power of the power converter 4 in the respective periods described above, that is, hatched portions (areas of the portions enclosed by waveforms) are defined as S′₄₂, S′₄₁, and S′₄₃, respectively, the following relation holds between S′₄₂, S′₄₁, and S′₄₃.

[Expression 3]

S′₄₂≈S′₄₁+S′₄₃≈0 Expression (3)

In addition, in the period from time 0 to time T₉, a positive power is generated at the alternating-current terminals of the power converter 5 in the period from time T₂ to time T₇, a positive power is generated at the alternating-current terminals of the power converter 6 in the period from time T₁ to time T₈, and a positive power is generated at the alternating-current terminals of the power converter 7 in the period from time 0 to time T₉.

Further, in the period from time T₉ to time T₁₀, positive or negative powers that have the same durations (same amplitude widths) and the same amplitude heights (absolute values) as the positive or negative powers obtained in the period from time 0 to time T₉, and which have the same amplitude direction as the positive or negative voltages are generated.

Here, when integrated amounts of power of the respective power converters 5, 6, and 7 in the respective periods described above, that is, hatched portions (areas of the portions enclosed by waveforms) are defined as S′₆, S′₆, and S′₇, respectively, the following relation holds between S′₆, S′₆, and S′₇ and the integrated amounts of power S₅, S₆, and S₇ of the respective power converters 5, 6, and 7 are shown in FIG. 9.

[Expression 4]

S′₅>S₅ Expression (4)

[Expression 5]

S′₆>S₆ Expression (5)

[Expression 6]

S′₇≈S₇ Expression (6)

Thus, the present embodiment can make the absolute value of the power usage rate of the power converter 4 zero and make the integrated amount of power of the power converter 4 during the period of one cycle substantially zero. Besides above, the present embodiment can make the amount of power received by the battery energy storage system 1 from the alternating-current power supply system 2 substantially equal to that during the normal operation shown in FIG. 7 by: extending the period of the positive voltage generated at the alternating-current terminals of the power converter 5 to the period from time T₂ to time T₇; extending the period of the positive voltage generated at the alternating-current terminals of the power converter 6 to the period from time T₁ to time T₈; and extending the period of the positive voltage generated at the alternating-current terminals of the power converter 7 to the period from time 0 to time T₉. As a result, the amounts of power generated at the alternating-current terminals of the power converters 5, 6, and 7 can be increased.

Hence, the present embodiment can make the integrated amount of power of a particular power converter substantially zero while maintaining the amount of power transferred between the battery energy storage system 1 and the alternating-current power supply system 2 in substantially a same state.

### <Description of Operation of Battery Energy Storage System 1 (3)>

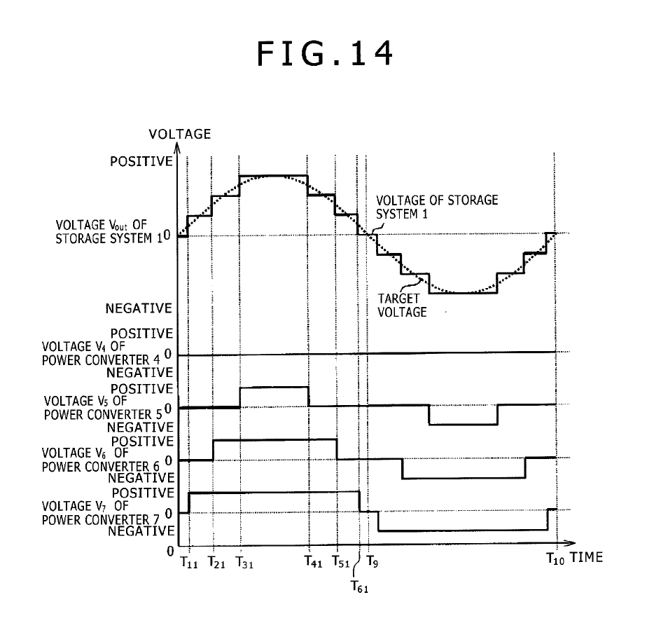

Another operation when the absolute value of the power usage rate of the power converter 4 in the battery energy storage system 1 is made to be zero will next be described with reference to FIGS. 14 to 16.

FIG. 14, in which an axis of ordinates indicates voltage (positive and negative) and an axis of abscissas indicates time, shows relation (in one cycle) between the voltage at the load side connection terminals of the battery energy storage system 1 as compared with the target voltage shown in FIG. 6 and the voltages generated at the alternating-current terminals 43 of the power converter 4 and the respective alternating-current terminals of the power converters 5, 6, and 7.

FIG. 14 shows, in order from a top, the voltage Vₒᵤₜ generated at the load side connection terminals of the battery energy storage system 1, the voltage V₄ generated at the alternating-current terminals 43 of the power converter 4, the voltage V₅ generated at the alternating-current terminals of the power converter 5, the voltage V₆ generated at the alternating-current terminals of the power converter 6, and the voltage V₇ generated at the alternating-current terminals of the power converter 7.

In addition, in FIG. 14, a point of intersection of the axis of ordinates and the axis of abscissas is set as a reference 0, an upper side of the reference 0 is set positive, and a lower side of the reference 0 is set negative.

Further, in FIG. 14, a dotted line represents the target voltage of the battery energy storage system 1, that is, the target voltage (modulated wave in the form of a sine wave) calculated in the central control device 12 and transmitted by signal transmission from the central control device 12 to the control device 44 of the power converter 4 and the respective control devices of the power converters 5, 6, and 7.

As shown in FIG. 14, the voltage pattern generated at the alternating-current terminals 43 of the power converter 4 is different from the voltage patterns shown in FIG. 7 and FIG. 11. To make the absolute value of the power usage rate of the power converter 4 zero, the voltage generated at the alternating-current terminals 43 of the power converter 4 is maintained at zero in all of the period from time 0 to time T₉ and the period from time T₉ to time T₁₀.

In addition, voltages in the form of rectangular waves which voltages have different amplitude reference potentials and different widths are generated at the alternating-current terminals of the power converters 5, 6, and 7.

Specifically, in the period from time 0 to time T₉, a positive voltage having the same amplitude height is generated at the alternating-current terminals of the power converter 5 in a period from time T₃₁ to time T₄₁, at the alternating-current terminals of the power converter 6 in a period from time T₂₁ to time T₅₁, and at the alternating-current terminals of the power converter 7 in a period from time T₁₁ to time T₆₁. In addition, in the period from time T₉ to time T₁₀, voltages (negative voltages) that have the same durations (same amplitude widths) and the same amplitude height (absolute value) as the positive voltages generated in the period from time 0 to time T₉, and which have an opposite amplitude direction from the positive voltages are generated symmetrically to the positive voltages.

The voltages generated at the alternating-current terminals of the power converters 5, 6, and 7 are combined with each other. As a result, a stepwise voltage corresponding to a target voltage is generated at the load side connection terminals of the battery energy storage system 1.

Here, to make the voltage pattern generated at the alternating-current terminals 43 of the power converter 4 zero, and generate the voltage to be generated at the load side connection terminals of the battery energy storage system 1 from the combination of the voltages generated at the respective alternating-current terminals of the power converters 5, 6, and 7, it suffices to make the amplitude of the command value (modulated wave) calculated in the central control device 12 and transmitted by signal transmission from the central control device 12 to the control device 44 of the power converter 4 and the respective control devices of the power converters 5, 6, and 7 smaller than that of the voltage patterns shown in FIG. 7 and FIG. 11. This makes it possible to make the voltage pattern generated at the alternating-current terminals 43 of the power converter 4 zero, and generate the voltage to be generated at the load side connection terminals of the battery energy storage system 1 from the combination of the voltages generated at the respective alternating-current terminals of the power converters 5, 6, and 7. However, the amplitude of the voltage generated at the load side connection terminals of the storage system 1 is also smaller than that of the voltage at the load side connection terminals of the storage system 1 which voltage is shown in FIG. 7 and FIG. 11.

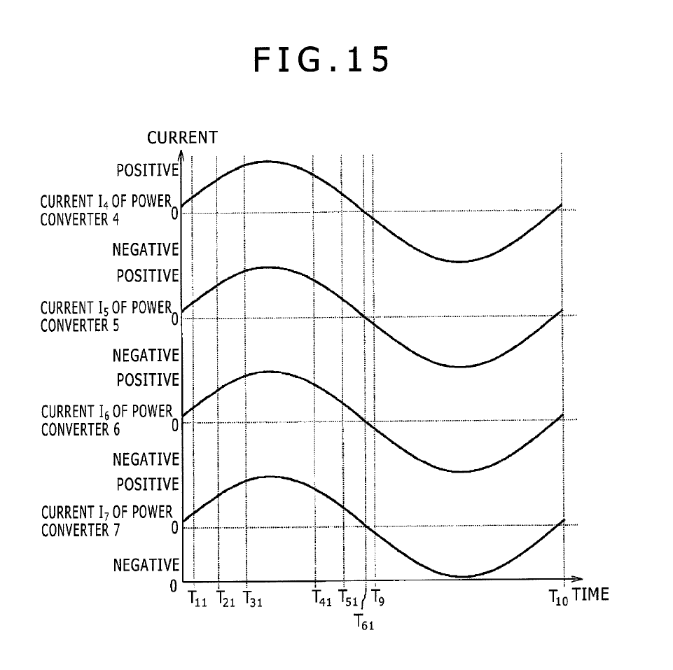

FIG. 15, in which an axis of ordinates indicates current (positive and negative) and an axis of abscissas indicates time, shows relation (in one cycle) between the currents flowing through the alternating-current terminals 43 of the power converter 4 and the respective alternating-current terminals of the power converters 5, 6, and 7.

FIG. 15 shows, in order from a top, the current I₄ flowing through the alternating-current terminals 43 of the power converter 4, the current I₅ flowing through the alternating-current terminals of the power converter 5, the current I₆ flowing through the alternating-current terminals of the power converter 6, and the current I₇ flowing through the alternating-current terminals of the power converter 7.

In addition, in FIG. 15, a point of intersection of the axis of ordinates and the axis of abscissas is set as a reference 0, an upper side of the reference 0 is set positive, and a lower side of the reference 0 is set negative.

As is clear from comparison between FIG. 6 and FIG. 15, the currents flowing through the alternating-current terminals 43 of the power converter 4 and the respective alternating-current terminals of the power converters 5, 6, and 7 (see FIG. 15) have the same amplitude (width and height) and the same phase as the current flowing between the transformer 3 and the load side connection terminal of the battery energy storage system 1 (see FIG. 6).

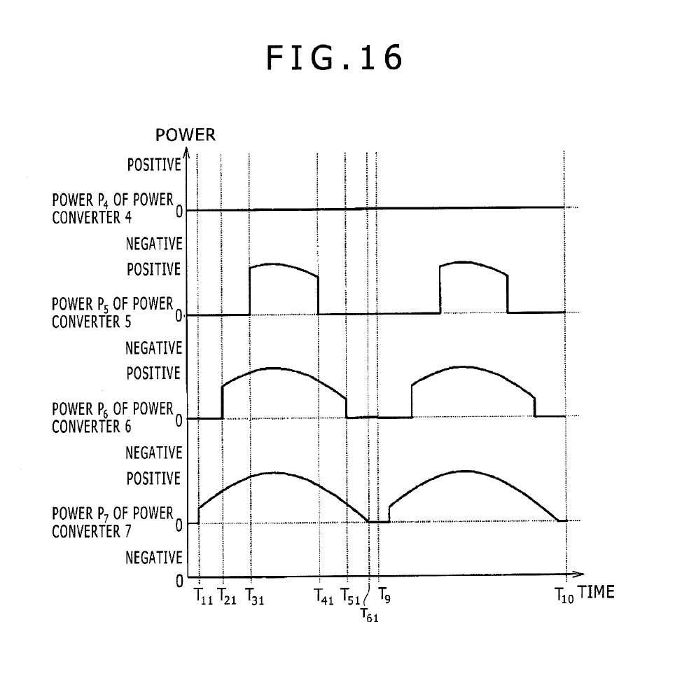

FIG. 16, in which an axis of ordinates indicates power (positive and negative) and an axis of abscissas indicates time, shows relation (in one cycle) between the powers generated at the alternating-current terminals 43 of the power converter 4 and the respective alternating-current terminals of the power converters 5, 6, and 7.

FIG. 16 shows, in order from a top, the power P₄ generated at the alternating-current terminals 43 of the power converter 4, the power P₅ generated at the alternating-current terminals of the power converter 5, the power P₆ generated at the alternating-current terminals of the power converter 6, and the power P₇ generated at the alternating-current terminals of the power converter 7.

In addition, in FIG. 16, a point of intersection of the axis of ordinates and the axis of abscissas is set as a reference 0, an upper side of the reference 0 is set positive, and a lower side of the reference 0 is set negative.

The powers generated at the alternating-current terminals 43 of the power converter 4 and the respective alternating-current terminals of the power converters 5, 6, and 7 are integrated values of the voltages generated at the alternating-current terminals 43 of the power converter 4 and the respective alternating-current terminals of the power converters 5, 6, and 7 (see FIG. 14) and the currents flowing through the alternating-current terminals 43 of the power converter 4 and the respective alternating-current terminals of the power converters 5, 6, and 7 (see FIG. 15).

Specifically, the power generated at the alternating-current terminals 43 of the power converter 4 is zero in all of the period from time 0 to time T₉.

In addition, in the period from time 0 to time T₉, a positive power is generated in the period from time T₃₁ to time T₄₁ at the alternating-current terminals of the power converter 5, a positive power is generated at the alternating-current terminals of the power converter 6 in the period from time T₂₁ to time T₅₁, and a positive power is generated at the alternating-current terminals of the power converter 7 in the period from time T₁₁ to time T₆₁.

Further, in the period from time T₉ to time T₁₀, positive powers that have the same durations (same amplitude widths) and the same amplitude height (absolute value) as the positive powers obtained in the period from time 0 to time T₉, and which have the same amplitude direction as the positive voltages are generated.

Also in the above-described case, the integrated amount of power of a particular power converter can be made to be substantially zero.

### <Action and Effect of Power Usage Rate Control>

According to the present embodiment described above, as described with reference to FIGS. 10 to 16, the absolute value of the power usage rate of a particular power converter can be made to be zero, and the integrated amount of power of the particular power converter can be made to be substantially zero. Thereby, according to the present embodiment, a plurality of power storage modules electrically connected in parallel with each other in an electric energy storage device electrically connected to the particular power converter can be selectively disconnected from the main circuit even during the operation of the battery energy storage system 1. When the power storage modules can be selectively disconnected from the main circuit during the operation of the storage system 1, a plurality of storage batteries forming a disconnected power storage module can be replaced during the operation of the storage system 1.

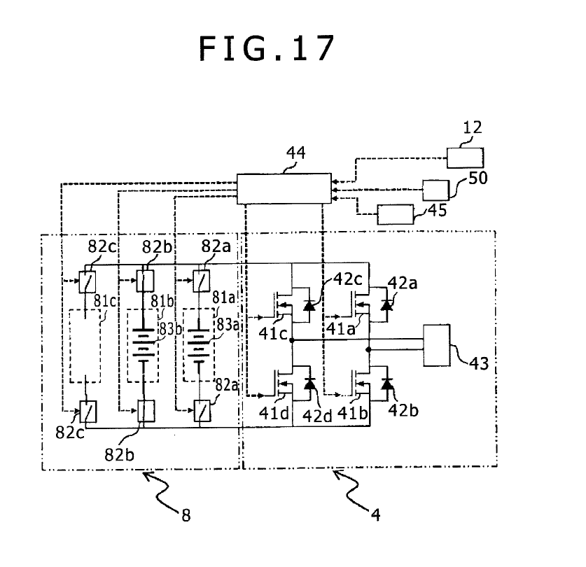

Specifically, from a state in which the switching devices of the switches 82a and 82b are on and thus the power storage modules 81a and 81b are electrically connected to the main circuit (power converter 4), as shown in FIG. 5, the absolute value of the power usage rate of the power converter 4 is made to be zero, and thereafter the power storage module 81a is electrically disconnected from the main circuit (power converter 4) by turning off the switching devices of the switches 82a, as shown in FIG. 17. Thereby the plurality of storage batteries 83a forming the power storage module 81a can be replaced.

Here, when the power storage module 81a is selected and disconnected, the current flowing through the power storage module 81b electrically connected to the main circuit is increased by the amount of current that flowed through the power storage module 81a that was electrically connected in parallel, and thus twice the current flows through the power storage module 81b, according to electrical theory. Generally, when a current larger than a specified value flows through a storage battery, degradation of the storage battery is accelerated, and the life of the storage battery is shortened. Therefore, the life of the plurality of storage batteries 83b forming the power storage module 81b is considered to be shortened significantly. However, the present embodiment does not greatly change the life of the plurality of storage batteries 83b forming the power storage module 81b. A reason for this is that in the present embodiment, as described repeatedly, the absolute value of the power usage rate of the power converter 4 is made to be zero, and thus the power balance of the power storage module 81b in one cycle is made to be zero, so that an increase in load on the plurality of storage batteries 83b forming the power storage module 81b can be kept to a minimum.

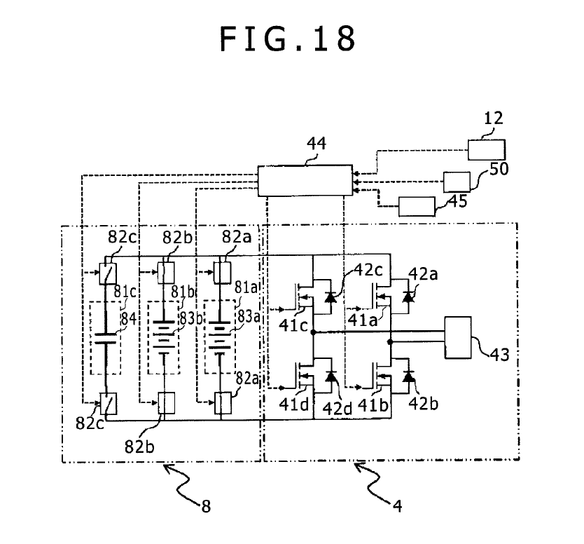

In addition, from the state shown in FIG. 5, another capacitor, for example a capacitor 84 is provided to the empty power storage module 81c, as shown in FIG. 18, the capacitor 84 of the power storage module 81c is electrically connected to the main circuit (power converter 4) by turning on the switching devices of the switches 82c, the absolute value of the power usage rate of the power converter 4 is made to be zero, and thereafter the power storage modules 81a and 81b are electrically disconnected from the main circuit (power converter 4) by turning off the switching devices of the switches 82a and 82b. Thereby the plurality of storage batteries 83a and 83b forming the power storage modules 81a and 81b can be replaced.

At this time, in the present embodiment, the absolute value of the power usage rate of the power converter 4 is made to be zero, and therefore the power balance of the capacitor 84 in one cycle is zero. When the capacitance of the capacitor 84 is selected appropriately, a voltage value on the side of the load side connection terminals (alternating-current terminals 43) of the power converter 4 can be held substantially constant even during operation. This enables the plurality of storage batteries 83a and 83b forming the power storage modules 81a and 81b to be replaced without changing a maximum value of amplitude of the voltage generated at the load side connection terminals of the battery energy storage system 1, and without stopping the storage system 1.

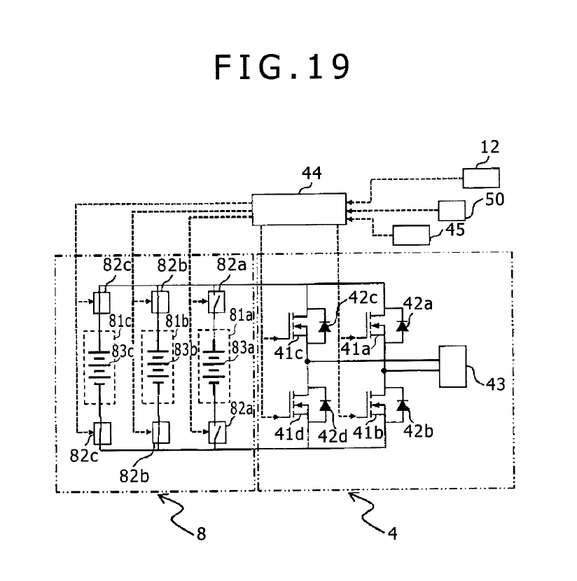

Further, from the state shown in FIG. 5, as shown in FIG. 19, a plurality of storage batteries 83c electrically connected in series with each other are provided to the empty power storage module 81c, the capacitor 84 of the power storage module 81c is electrically connected to the main circuit (power converter 4) by turning on the switching devices of the switches 82c, the absolute value of the power usage rate of the power converter 4 is made to be zero, and thereafter the power storage module 81a is electrically disconnected from the main circuit (power converter 4) by turning off the switching devices of the switches 82a. Thereby the plurality of storage batteries 83a forming the power storage module 81a can be replaced.

At this time, in the present embodiment, the state of the power storage modules electrically connected to the power converter 4 can be subsequently set under a similar operating condition to that of the state of FIG. 5, and the absolute value of the power usage rate of the power converter 4 is made to be zero. Therefore the plurality of storage batteries 83a of the power storage module 81a can be replaced while changes in state of charge of the plurality of storage batteries 83c are minimized, and without the battery energy storage system 1 being stopped.

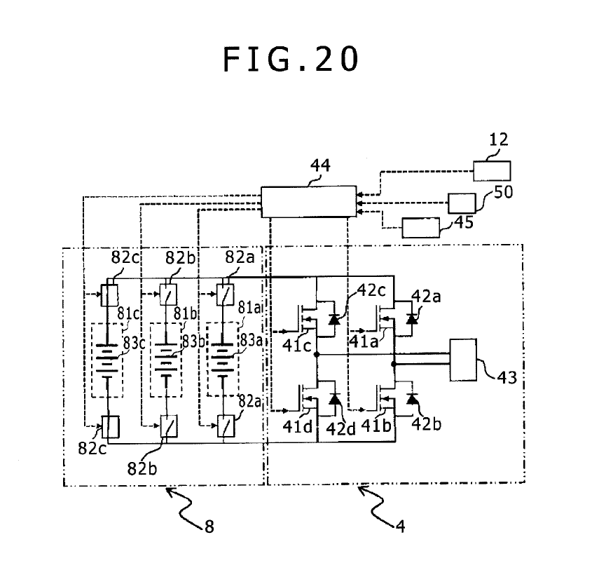

Further, from the state shown in FIG. 5, as shown in FIG. 20, a plurality of storage batteries 83c electrically connected in series with each other are provided to the empty power storage module 81c, the capacitor 84 of the power storage module 81c is electrically connected to the main circuit (power converter 4) by turning on the switching devices of the switches 82c, the absolute value of the power usage rate of the power converter 4 is made to be zero, and thereafter the power storage modules 81a and 81b are electrically disconnected from the main circuit (power converter 4) by turning off the switching devices of the switches 82a and 82b. Thereby the plurality of storage batteries 83a and 83b forming the power storage modules 81a and 81b can be replaced.

At this time, in the present embodiment, the absolute value of the power usage rate of the power converter 4 is made to be zero. Therefore the plurality of storage batteries 83a and 83b of the power storage modules 81a and 81b can be replaced while changes in state of charge of the plurality of storage batteries 83c are minimized, and without the battery energy storage system 1 being stopped.

<Procedures for Replacing Storage Battery without Stopping Battery Energy Storage System 1>

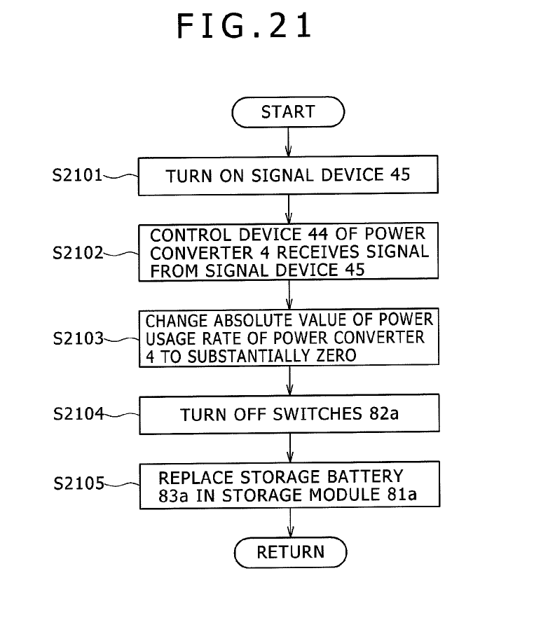

The storage battery replacing procedures described with reference to FIGS. 17 to 20 will next be described concretely with reference to FIGS. 21 to 32.

FIGS. 21 to 23 illustrate the storage battery replacing procedure shown in FIG. 17. There are a case where a trigger for performing storage battery replacement is based on a signal from the signal device 45 and a case where a trigger for performing storage battery replacement is based on a signal from the external device 50.

FIG. 21 shows a procedure for replacing a storage battery with a signal from the signal device 45 as a trigger.

When the signal device 45 is turned on by operating the button or the lever of the signal device 45 in step S2101, a signal is output from the signal device 45. When the control device 44 of the power converter 4 receives the signal output from the signal device 45 in step S2102, the control device 44 of the power converter 4 in step S2103 changes the absolute value of the power usage rate of the power converter 4 to substantially zero on the basis of the signal output from the signal device 45. After the absolute value of the power usage rate of the power converter 4 is thereby changed to substantially zero, the power storage module 81a is electrically disconnected from the main circuit (power converter 4) by turning off the switching devices of the switches 82a in step 2104. Then, in step 2105, the state of the plurality of storage batteries 83a of the power storage module 81a is checked, and when there is a storage battery 83a in need of replacement, the storage battery 83a is replaced with a new storage battery. When a storage battery 83a in need of replacement is known in advance, the storage battery 83a in need of replacement is replaced with a new storage battery in step 2105 after the process of step 2104.

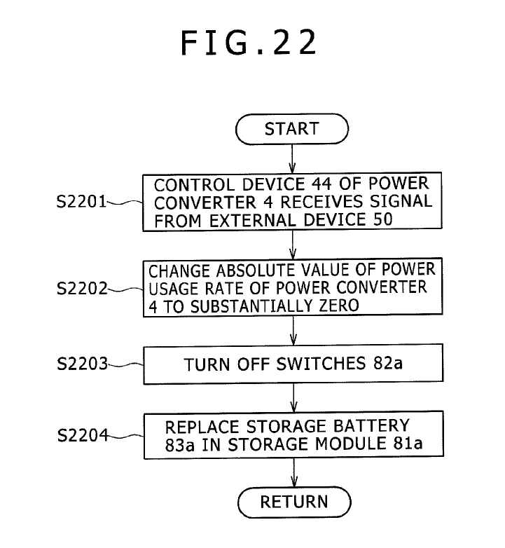

FIG. 22 shows a procedure for replacing a storage battery with a signal from the external device 50 as a trigger.

When the control device 44 of the power converter 4 receives a signal output from the external device 50 in step S2202, the control device 44 of the power converter 4 in step S2201 changes the absolute value of the power usage rate of the power converter 4 to substantially zero on the basis of the signal output from the external device 50. After the absolute value of the power usage rate of the power converter 4 is thereby changed to substantially zero, the power storage module 81a is electrically disconnected from the main circuit (power converter 4) by turning off the switching devices of the switches 82a in step 2203. Then, in step 2204, a storage battery 83a in need of replacement is replaced with a new storage battery.

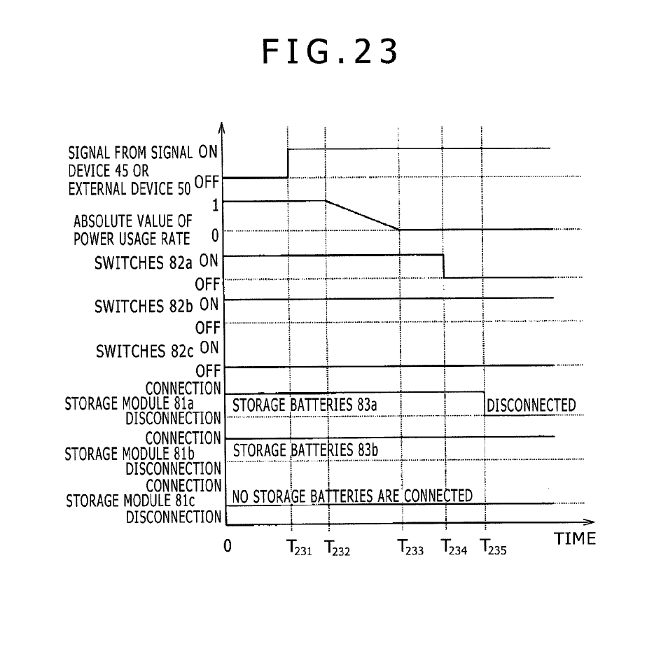

FIG. 23 shows temporal changes in operation and state of each device and temporal changes in signals and characteristics when the storage battery replacing procedure based on FIG. 21 or FIG. 22 is performed.

In FIG. 23, an axis of abscissas indicates time, and an axis of ordinates indicates, from the top of the figure, the state of the signal output from the signal device 45 or the external device 50, a state of change in the absolute value of the power usage rate of the power converter 4, the switching state of the switching devices of the switches 82a, the switching state of the switching devices of the switches 82b, the switching state of the switching devices of the switches 82c, the state of connection of the power storage module 81a, the state of connection of the power storage module 81b, and the state of connection of the power storage module 81c.

In addition, in each state in FIG. 23, a point of intersection of the axis of ordinates and the axis of abscissas is set as “OFF”, “0”, or “disconnection”, and an upper side of the point of intersection is set as “ON”, “1”, or “connection”.

In a period from time 0 to time T₂₃₁, there is no signal from the signal device 45 or the external device 50, and the switching devices of the switches 82a and 82b are in an on state, so that the plurality of storage batteries 83a and 83b of the power storage modules 81a and 81b are electrically connected to the power converter 4 having a power usage rate of one. In addition, because no storage batteries are provided to the power storage module 81c, the state of connection of the power storage module 81c is a disconnected state, and the switching devices of the switches 82c are in an off state.

At time T₂₃₂ after the passage of a predetermined time from time T₂₃₁, at which time T₂₃₁ a signal is output from the signal device 47 or the external device 50 and thus the state of the signal becomes an on state, the absolute value of the power usage rate of the power converter 4 starts to decrease. At time T₂₃₃, the absolute value of the power usage rate of the power converter 4 becomes substantially zero. Thereafter, at time T₂₃₄ after the passage of a predetermined time, the switching devices of the switches 82a are turned off. At time T₂₃₅ after the passage of a predetermined time, the power storage module 81a is electrically disconnected from the power converter 4. After time T₂₃₅, that state is maintained, and a storage battery 83a is replaced.

Incidentally, in making the absolute value of the power usage rate of the power converter 4 zero, the absolute value of the power usage rate of the power converter 4 is changed so as to decrease linearly (in the form of a ramp), as shown in FIG. 23. However, the absolute value of the power usage rate of the power converter 4 may be changed so as to decrease stepwise, or a degree of decrease in the absolute value of the power usage rate of the power converter 4 with respect to a unit time may be changed with respect to time.

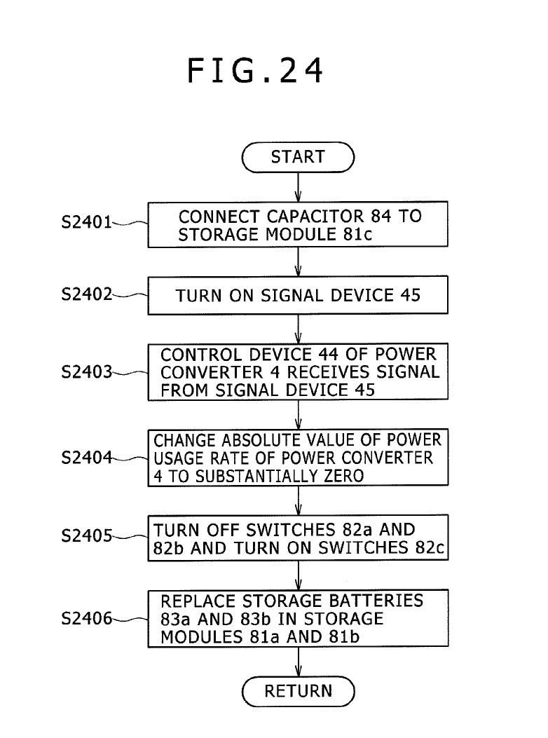

FIGS. 24 to 26 illustrate the storage battery replacing procedure shown in FIG. 18.

FIG. 24 shows a procedure for replacing storage batteries with a signal from the signal device 45 as a trigger.

First, in step S2401, a capacitor 84 is installed in the power storage module 81c. Next, when the signal device 45 is turned on by operating the button or the lever of the signal device 45 in step S2402, a signal is output from the signal device 45. When the control device 44 of the power converter 4 receives the signal output from the signal device 45 in step S2403, the control device 44 of the power converter 4 in step S2404 changes the absolute value of the power usage rate of the power converter 4 to substantially zero on the basis of the signal output from the signal device 45. After the absolute value of the power usage rate of the power converter 4 is thereby changed to substantially zero, in step 2405, the power storage modules 81a and 81b are electrically disconnected from the main circuit (power converter 4) by turning off the switching devices of the switches 82a and 82b, and the power storage module 81c is electrically connected to the main circuit (power converter 4) by turning on the switching devices of the switches 82c. Then, in step 2406, the state of the plurality of storage batteries 83a and 83b of the power storage modules 81a and 81b is checked, and when there are storage batteries 83a and 83b in need of replacement, the storage batteries 83a and 83b are replaced with a new storage battery. When storage batteries 83a and 83b in need of replacement are known in advance, the storage batteries 83a and 83b in need of replacement are replaced with a new storage battery in step 2406 after the process of step 2405.

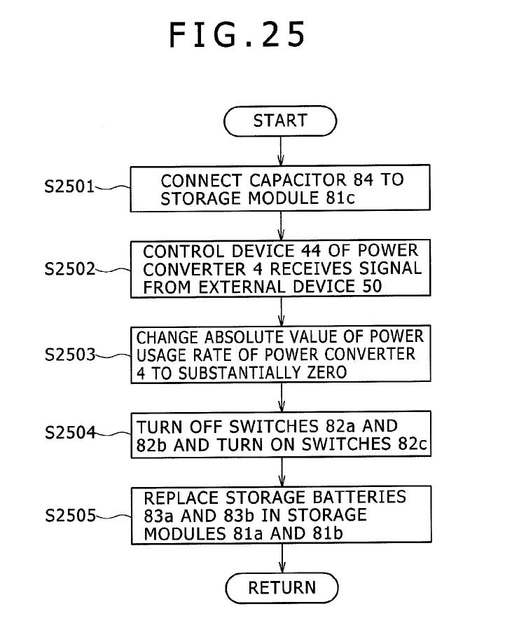

FIG. 25 shows a procedure for replacing storage batteries with a signal from the external device 50 as a trigger.

First, in step S2501, a capacitor 84 is installed in the power storage module 81c. Next, when the control device 44 of the power converter 4 receives a signal output from the external device 50 in step S2502, the control device 44 of the power converter 4 in step S2503 changes the absolute value of the power usage rate of the power converter 4 to substantially zero on the basis of the signal output from the external device 50. After the absolute value of the power usage rate of the power converter 4 is thereby changed to substantially zero, in step 2504, the power storage modules 81a and 81b are electrically disconnected to the main circuit (power converter 4) by turning off the switching devices of the switches 82a and 82b, and the power storage module 81c is electrically connected from the main circuit (power converter 4) by turning on the switching devices of the switches 82c. Then, in step 2505, storage batteries 83a and 83b in need of replacement are replaced with a new storage battery.

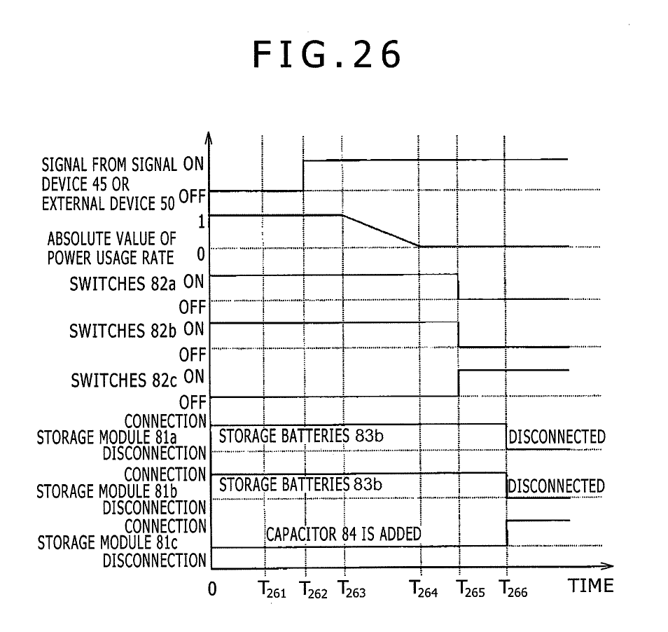

FIG. 26 shows temporal changes in operation and state of each device and temporal changes in signals and characteristics when the storage battery replacing procedure based on FIG. 24 or FIG. 25 is performed.

In FIG. 26, an axis of abscissas indicates time, and an axis of ordinates indicates, from the top of the figure, the state of the signal output from the signal device 45 or the external device 50, a state of change in the absolute value of the power usage rate of the power converter 4, the switching state of the switching devices of the switches 82a, the switching state of the switching devices of the switches 82b, the switching state of the switching devices of the switches 82c, the state of connection of the power storage module 81a, the state of connection of the power storage module 81b, and the state of connection of the power storage module 81c.

In addition, in each state in FIG. 26, a point of intersection of the axis of ordinates and the axis of abscissas is set as “OFF”, “0”, or “disconnection”, and an upper side of the point of intersection is set as “ON”, “1”, or “connection”.

In a period from time 0 to time T₂₆₂, there is no signal from the signal device 45 or the external device 50, and the switching devices of the switches 82a and 82b are in an on state, so that the plurality of storage batteries 83a and 83b of the power storage modules 81a and 81b are electrically connected to the power converter 4 having a power usage rate of one. In this state, at time T₂₆₁, a capacitor 84 is provided to the power storage module 81c, and the switching devices of the switches 82c are kept as they are in an off state.

At time T₂₆₃ after the passage of a predetermined time from time T₂₆₂, at which time T₂₆₂ a signal is output from the signal device 45 or the external device 50 and thus the state of the signal becomes an on state, the absolute value of the power usage rate of the power converter 4 starts to decrease. At time T₂₆₄, the absolute value of the power usage rate of the power converter 4 becomes substantially zero. Thereafter, at time T₂₆₅ after the passage of a predetermined time, the switching devices of the switches 82a and 82b are turned off, and the switching devices of the switches 82c are turned on. At time T₂₆₆ after the passage of a predetermined time, the power storage modules 81a and 81b are electrically disconnected from the power converter 4, and the power storage module 81c is electrically connected to the power converter 4. After time T₂₆₆, that state is maintained, and storage batteries 83a and 83b are replaced.

Incidentally, the capacitor 84 may be charged in advance, or the capacitor 84 may be charged in a mode of charging the capacitor 84 which mode is provided in a period from time T₂₆₁ to time T₂₆₂.

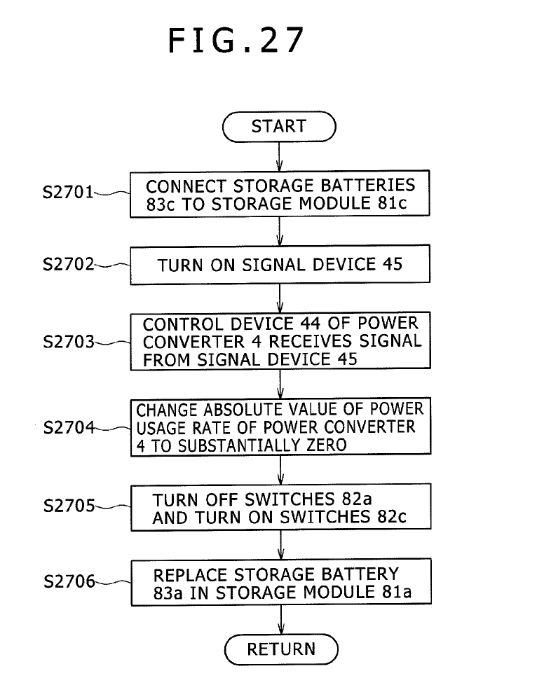

FIGS. 27 to 29 illustrate the storage battery replacing procedure shown in FIG. 19.

FIG. 27 shows a procedure for replacing a storage battery with a signal from the signal device 45 as a trigger.

First, in step S2701, a plurality of storage batteries 83c electrically connected in series with each other are installed in the power storage module 81c. Next, when the signal device 45 is turned on by operating the button or the lever of the signal device 45 in step S2702, a signal is output from the signal device 45. When the control device 44 of the power converter 4 receives the signal output from the signal device 45 in step S2703, the control device 44 of the power converter 4 in step S2704 changes the absolute value of the power usage rate of the power converter 4 to substantially zero on the basis of the signal output from the signal device 45. After the absolute value of the power usage rate of the power converter 4 is thereby changed to substantially zero, in step 2705, the power storage module 81a is electrically disconnected from the main circuit (power converter 4) by turning off the switching devices of the switches 82a, and the power storage module 81c is electrically connected to the main circuit (power converter 4) by turning on the switching devices of the switches 82c. Then, in step 2706, the state of the plurality of storage batteries 83a of the power storage modules 81a is checked, and when there is a storage battery 83a in need of replacement, the storage battery 83a is replaced with a new storage battery. When a storage battery 83a in need of replacement is known in advance, the storage battery 83a in need of replacement is replaced with a new storage battery in step 2706 after the process of step 2705.

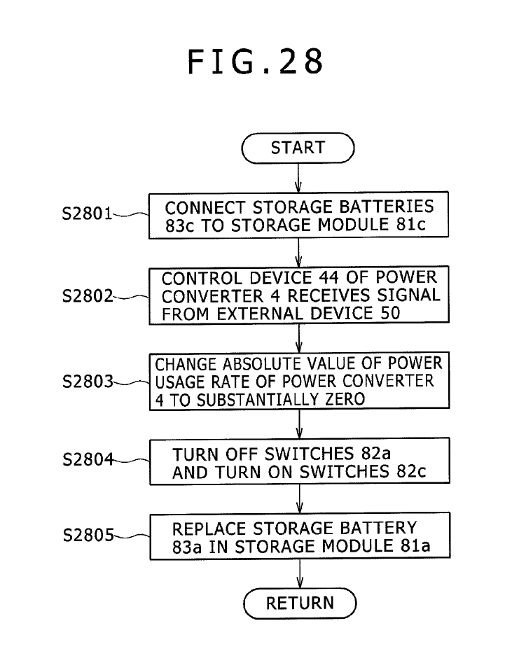

FIG. 28 shows a procedure for replacing a storage battery with a signal from the external device 50 as a trigger.

First, in step S2801, a plurality of storage batteries 83c electrically connected in series with each other are installed in the power storage module 81c. Next, when the control device 44 of the power converter 4 receives a signal output from the external device 50 in step S2802, the control device 44 of the power converter 4 in step S2803 changes the absolute value of the power usage rate of the power converter 4 to substantially zero on the basis of the signal output from the external device 50. After the absolute value of the power usage rate of the power converter 4 is thereby changed to substantially zero, in step 2804, the power storage module 81a is electrically disconnected from the main circuit (power converter 4) by turning off the switching devices of the switches 82a, and the power storage module 81c is electrically connected to the main circuit (power converter 4) by turning on the switching devices of the switches 82c. Then, in step 2805, a storage battery 83a in need of replacement is replaced with a new storage battery.

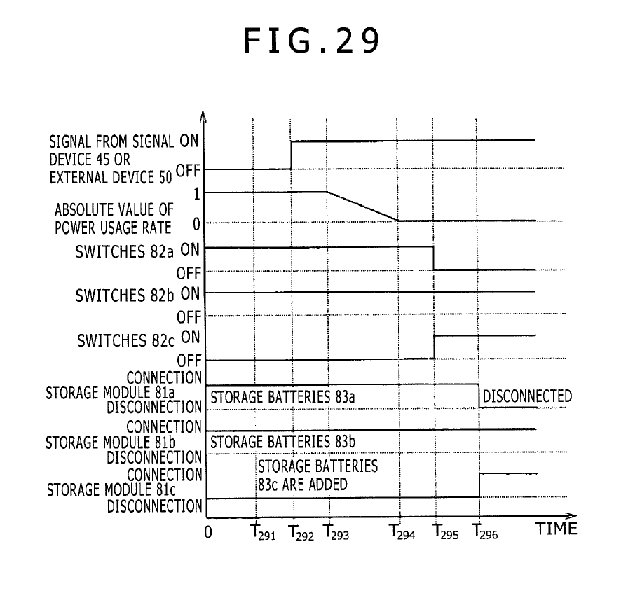

FIG. 29 shows temporal changes in operation and state of each device and temporal changes in signals and characteristics when the storage battery replacing procedure based on FIG. 27 or FIG. 28 is performed.

In FIG. 29, an axis of abscissas indicates time, and an axis of ordinates indicates, from the top of the figure, the state of the signal output from the signal device 45 or the external device 50, a state of change in the absolute value of the power usage rate of the power converter 4, the switching state of the switching devices of the switches 82a, the switching state of the switching devices of the switches 82b, the switching state of the switching devices of the switches 82c, the state of connection of the power storage module 81a, the state of connection of the power storage module 81b, and the state of connection of the power storage module 81c.

In addition, in each state in FIG. 29, a point of intersection of the axis of ordinates and the axis of abscissas is set as “OFF”, “0”, or “disconnection”, and an upper side of the point of intersection is set as “ON”, “1”, or “connection”.

In a period from time 0 to time T₂₉₂, there is no signal from the signal device 45 or the external device 50, and the switching devices of the switches 82a and 82b are in an on state, so that the plurality of storage batteries 83a and 83b of the power storage modules 81a and 81b are electrically connected to the power converter 4 having a power usage rate of one. In this state, at time T₂₉₁, a plurality of storage batteries 83c electrically connected in series with each other are provided to the power storage module 81c, and the switching devices of the switches 82c are kept as they are in an off state.

At time T₂₉₃ after the passage of a predetermined time from time T₂₉₂, at which time T₂₉₂ a signal is output from the signal device 47 or the external device 50 and thus the state of the signal becomes an on state, the absolute value of the power usage rate of the power converter 4 starts to decrease. At time T₂₉₄, the absolute value of the power usage rate of the power converter 4 becomes substantially zero. Thereafter, at time T₂₉₅ after the passage of a predetermined time, the switching devices of the switches 82a are turned off, and the switching devices of the switches 82c are turned on. At time T₂₉₆ after the passage of a predetermined time, the power storage module 81a is electrically disconnected from the power converter 4, and the power storage module 81c is electrically connected to the power converter 4. After time T₂₉₆, that state is maintained, and a storage battery 83a is replaced.

Incidentally, the plurality of storage batteries 83c may be charged in advance, or the plurality of storage batteries 83c may be charged in a mode of charging the plurality of storage batteries 83c which mode is provided in a period from time T₂₉₂ to time T₂₉₂.

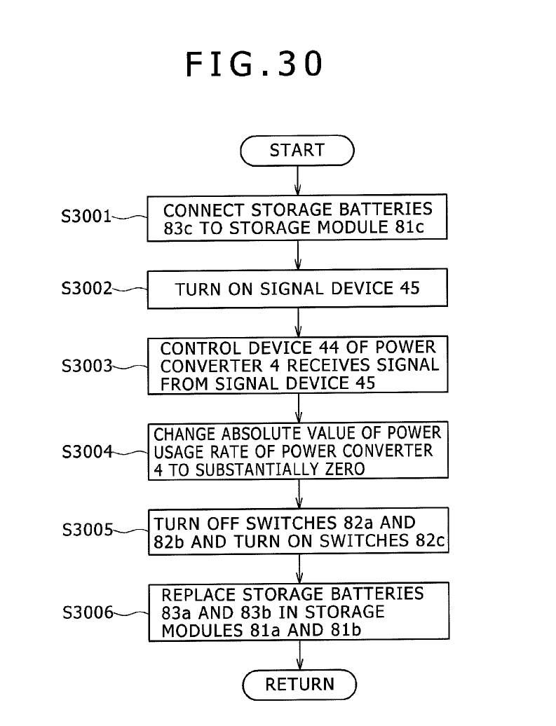

FIGS. 30 to 32 illustrate the storage battery replacing procedure shown in FIG. 20.

FIG. 30 shows a procedure for replacing storage batteries with a signal from the signal device 45 as a trigger.

First, in step S3001, a plurality of storage batteries 83c electrically connected in series with each other are installed in the power storage module 81c. Next, when the signal device 45 is turned on by operating the button or the lever of the signal device 45 in step S3002, a signal is output from the signal device 45. When the control device 44 of the power converter 4 receives the signal output from the signal device 45 in step S3003, the control device 44 of the power converter 4 in step S3004 changes the absolute value of the power usage rate of the power converter 4 to substantially zero on the basis of the signal output from the signal device 45. After the absolute value of the power usage rate of the power converter 4 is thereby changed to substantially zero, in step 3005, the power storage modules 81a and 81b are electrically disconnected from the main circuit (power converter 4) by turning off the switching devices of the switches 82a and 82b, and the power storage module 81c is electrically connected to the main circuit (power converter 4) by turning on the switching devices of the switches 82c. Then, in step 3006, the state of the plurality of storage batteries 83a and 83b of the power storage modules 81a and 81b is checked, and when there are storage batteries 83a and 83b in need of replacement, the storage batteries 83a and 83b are replaced with a new storage battery. When storage batteries 83a and 83b in need of replacement are known in advance, the storage batteries 83a and 83b in need of replacement are replaced with a new storage battery in step 3006 after the process of step 3005.

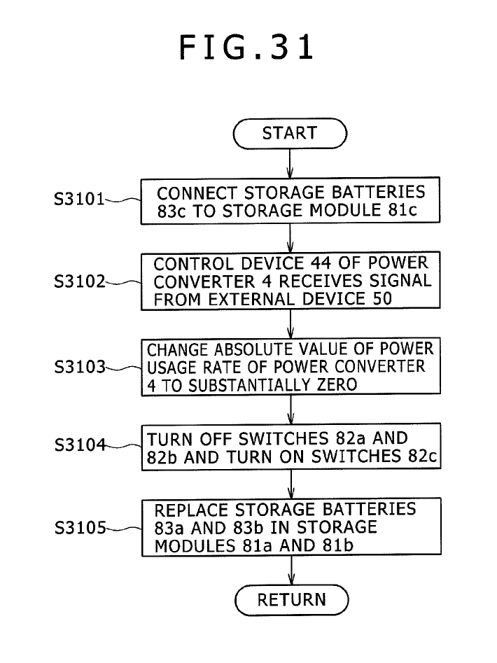

FIG. 31 shows a procedure for replacing storage batteries with a signal from the external device 50 as a trigger.

First, in step S3101, a plurality of storage batteries 83c electrically connected in series with each other are installed in the power storage module 81c. Next, when the control device 44 of the power converter 4 receives a signal output from the external device 50 in step S3102, the control device 44 of the power converter 4 in step S3103 changes the absolute value of the power usage rate of the power converter 4 to substantially zero on the basis of the signal output from the external device 50. After the absolute value of the power usage rate of the power converter 4 is thereby changed to substantially zero, in step 3104, the power storage modules 81a and 81b are electrically disconnected from the main circuit (power converter 4) by turning off the switching devices of the switches 82a and 82b, and the power storage module 81c is electrically connected to the main circuit (power converter 4) by turning on the switching devices of the switches 82c. Then, in step 3105, storage batteries 83a and 83b in need of replacement are replaced with a new storage battery.

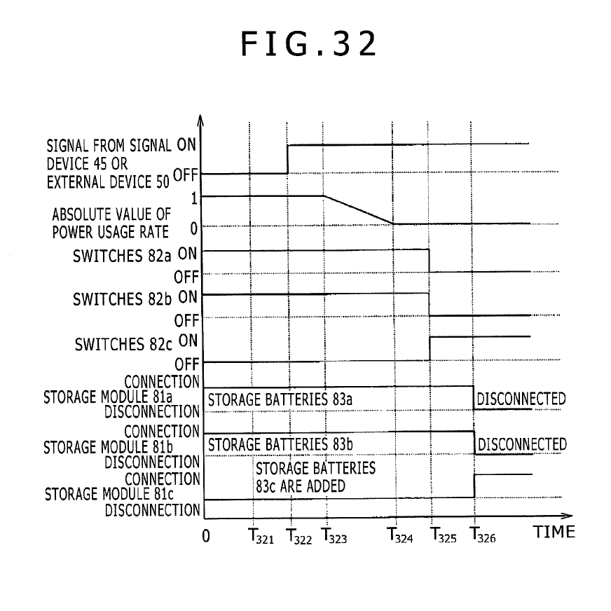

FIG. 32 shows temporal changes in operation and state of each device and temporal changes in signals and characteristics when the storage battery replacing procedure based on FIG. 30 or FIG. 31 is performed.

In FIG. 32, an axis of abscissas indicates time, and an axis of ordinates indicates, from the top of the figure, the state of the signal output from the signal device 45 or the external device 50, a state of change in the absolute value of the power usage rate of the power converter 4, the switching state of the switching devices of the switches 82a, the switching state of the switching devices of the switches 82b, the switching state of the switching devices of the switches 82c, the state of connection of the power storage module 81a, the state of connection of the power storage module 81b, and the state of connection of the power storage module 81c.

In addition, in each state in FIG. 32, a point of intersection of the axis of ordinates and the axis of abscissas is set as “OFF”, “0”, or “disconnection”, and an upper side of the point of intersection is set as “ON”, “1”, or “connection”.

In a period from time 0 to time T₃₂₂, there is no signal from the signal device 45 or the external device 50, and the switching devices of the switches 82a and 82b are in an on state, so that the plurality of storage batteries 83a and 83b of the power storage modules 81a and 81b are electrically connected to the power converter 4 having a power usage rate of one. In this state, at time T₃₂₁, a plurality of storage batteries 83c electrically connected in series with each other are provided to the power storage module 81c, and the switching devices of the switches 82c are kept as they are in an off state.

At time T₃₂₃ after the passage of a predetermined time from time T₃₂₂, at which time T₃₂₂ a signal is output from the signal device 45 or the external device 50 and thus the state of the signal becomes an on state, the absolute value of the power usage rate of the power converter 4 starts to decrease. At time T₃₂₄, the absolute value of the power usage rate of the power converter 4 becomes substantially zero. Thereafter, at time T₃₂₅ after the passage of a predetermined time, the switching devices of the switches 82a and 82b are turned off, and the switching devices of the switches 82c are turned on. At time T₃₂₆ after the passage of a predetermined time, the power storage modules 81a and 81b are electrically disconnected from the power converter 4, and the power storage module 81c is electrically connected to the power converter 4. After time T₃₂₆, that state is maintained, and storage batteries 83a and 83b are replaced.

Incidentally, the plurality of storage batteries 83c may be charged in advance, or the plurality of storage batteries 83c may be charged in a mode of charging the plurality of storage batteries 83c which mode is provided in a period from time T₃₂₁ to time T₃₂₂.

### <Hardware Configuration of Battery Energy Storage System 1>

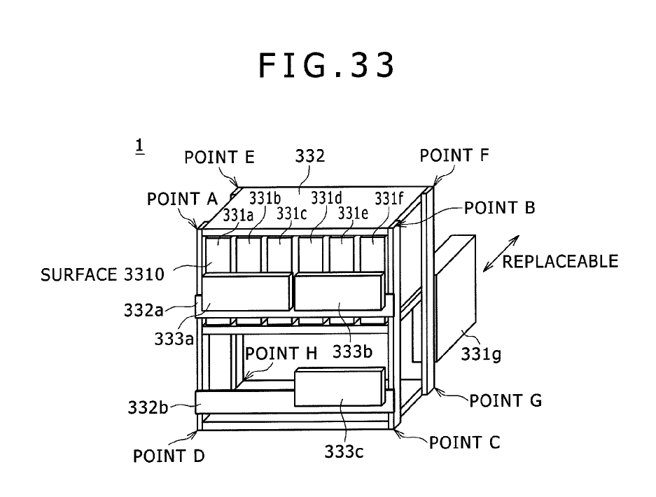

An actual hardware configuration of the battery energy storage system 1 will next be described with reference to FIGS. 33 to 37.

FIG. 33 shows an actual hardware configuration of the battery energy storage system 1 shown in FIG. 1.

FIG. 33 does not show a part of constituent elements of the battery energy storage system 1 shown in FIG. 1. While FIG. 1 shows four connected pairs of power converters and electric energy storage devices, FIG. 33 shows three of the four connected pairs, and shows only one power storage module forming the electric energy storage device of the third pair.

As shown in FIG. 33, the battery energy storage system 1 has an installation stand 332 made of a metal such as iron, steel. Four pairs of power converters and electric energy storage devices are mounted in the installation stand 332.

Here, when eight corners of the installation stand 332 are set as points A to H, the installation stand 332 is a hexahedron formed so as to be enclosed by six surfaces, that is, a rectangular surface ABCD formed by connecting points A to D, a rectangular surface EFGH formed by connecting points E to H, a rectangular surface ADHE formed by connecting point A, point D, point E, and point H, a rectangular surface BDGF formed by connecting point B, point C, point F, and point G, a rectangular surface ABFE formed by connecting point A, point B, point E, and point F, and a rectangular surface CDHG formed by connecting point C, point D, point G, and point H. The installation stand 332 is thus a structure in the shape of a rectangular parallelepiped, with the surface ABCD and the surface EFGH opposed to each other among the six surfaces having a largest area, the surface ADEH and the surface BCGF opposed to each other having a smallest area, and the surface ABEF and the surface CDGH opposed to each other having an area intermediate between the largest area and the smallest area.

The installation stand 332 is a rack formed so as to have two tiers, that is, an upper tier and a lower tier. A partition board is provided in an intermediate portion between an upper portion and a lower portion of the installation stand 332. The partition board has a same size as a top board and a bottom board provided to the surface ABEF and the surface CDGH. Edges of the top board, the bottom board, and the partition board which edges are on the side of the surface ADEH and the side of the surface BCGF are fixed to and retained by elongate column boards provided so as to extend along edges of the surface ADEH and the surface BCGF which edges are on the side of the surface ABCD and the side of the surface EFGH. Elongate power converter attaching boards 332a and 332b corresponding to the upper and lower tiers, respectively, are provided to the surface ABCD of the installation stand 332 so as to extend from the surface ADEH to the surface BCGF, and are each fixed to and retained by column boards. The surface EFGH side of the installation stand 332 is opened. The surface ABCD side of the installation stand 332 is partially closed by the power converter attaching boards 332a and 332b.

Power storage modules 331a to 331f forming electric energy storage devices of two pairs are installed in the upper tier of the installation stand 332. A plurality of power storage modules forming electric energy storage devices of two pairs, which power storage modules include a power storage module 331g, are installed in the lower tier of the installation stand 332.

The power storage modules 331a to 331g are each a structure formed by housing a plurality of storage batteries electrically connected in series with each other in a module case in the shape of a rectangular parallelepiped formed so as to be enclosed by two rectangular principal surfaces opposed to each other and four rectangular side surfaces arranged along edges of the two principal surfaces so as to be perpendicular to the two principal surfaces, the four rectangular side surfaces having a smaller area than the principal surfaces. In this case, the module case in the shape of a rectangular parallelepiped has a flat shape such that a distance (dimension in a direction of width) between the two principal surfaces opposed to each other is smaller than lengths of four sides of the principal surfaces (dimensions in a direction of depth and a direction of height).

The power storage modules 331a to 331g are each inserted from the opened side of the surface EFGH of the installation stand 332 into the corresponding tier such that a surface 3310 (one of side surfaces) of the module case is opposed to the surface ABCD of the installation stand 332. Thereby, in the upper tier of the installation stand 332, the power storage modules 331a to 331f are arranged in juxtaposition with each other from one side of the surface ADEH and the surface BCFG of the installation stand 332 to the other side such that the principal surfaces of the module cases face the surface ADEH and the surface BCFG of the installation stand 332. In the lower tier of the installation stand 332, the plurality of power storage modules including the power storage module 331g are arranged in juxtaposition with each other as in the upper tier. The surfaces 3310 of the module cases are provided with connection terminals for connection to a power converter. The power storage modules are configured to be connected to a power converter by being inserted into the installation stand 332.

A power converter 333a corresponding to the power storage modules 331a to 331c and a power converter 333b corresponding to the power storage modules 331d to 331f are attached to an opposite side of the power converter attaching board 332a from the side of the power storage modules 331a to 331f in such a manner as to be arranged from a left side to a right side. A power converter 333c corresponding to a plurality of power storage modules including the power storage module 331g and a power converter (not shown) corresponding to a plurality of other power storage modules are attached to an opposite side of the power converter attaching board 332a from the side of the plurality of power storage modules including the power storage module 331g in such a manner as to be arranged from a left side to a right side.

In the thus configured battery energy storage system 1, when a storage battery is replaced, a power storage module including the storage battery to be replaced, for example the power storage module 331g can be removed easily by merely extracting the power storage module horizontally from the opened side of the surface EFGH of the installation stand 332 in an opposite direction from the surface ABCD of the installation stand 332. In addition, the plurality of power converters including the power converters 333a to 333c are retained by the power converter attaching boards 332a and 332b in such a manner as to be separated from the power storage modules 331a to 331g. Thus, when the power storage module including the storage battery to be replaced, for example the power storage module 331g is removed, only the power storage module 331g can be removed without involving the removal of the plurality of power converters including the power converters 333a to 333c. Therefore the work of removing the power storage module 331g can be performed easily.

Incidentally, in the present embodiment, the arrangement of the central control device 12, the voltage measuring device 13, the current measuring device 14, the transformer 3 and the cables for electrically connecting the above devices are not shown, but may be provided on the top board of the installation stand 332, on the side of the installation stand 332, or further, on an additional tier portion of the installation stand 332.

In addition, while in the present embodiment, the plurality of power storage modules 331a to 331f are arranged horizontally, the plurality of power storage modules 331a to 331f may be piled up vertically.

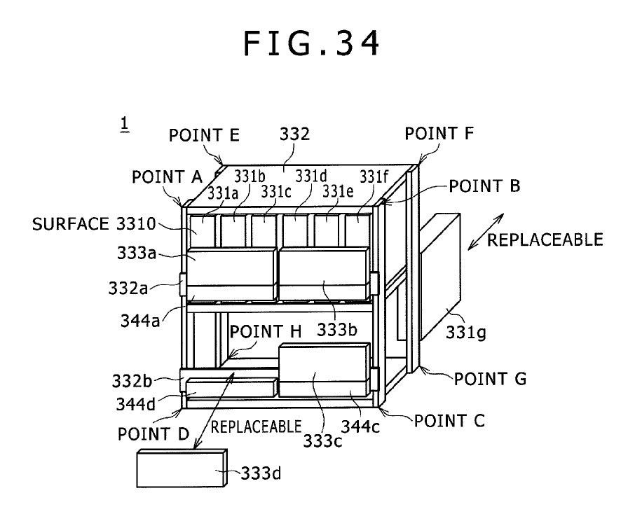

Further, in describing the hardware configuration of the battery energy storage system 1 in FIG. 1, different references from the references used in FIG. 1 are used in FIG. 33. Correspondence relations between the power converters and the electric energy storage devices of FIG. 1 and the power converters and the electric energy storage devices of FIG. 33 are as follows. Similar relations hold in FIG. 34 and subsequent figures.

Power converter 4 to 6 correspond to power converter 333a to 333c, respectively;

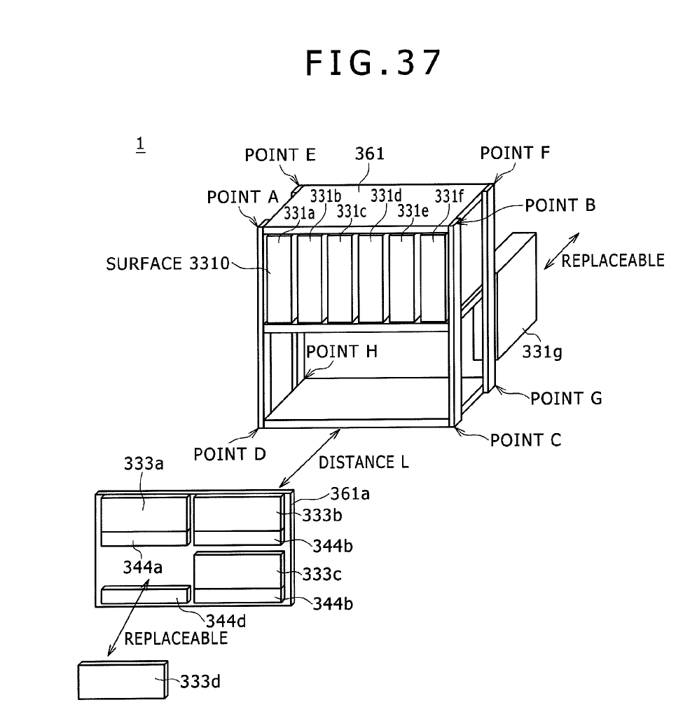

power converter 7 corresponds to power converter (not shown) (power converter 333d in FIG. 34 and FIG. 37);

power storage modules 81a to 81c correspond to power storage modules 331a to 331c, respectively;

three power storage modules (not shown) of electric energy storage device 9 correspond to power storage modules 331d, 331e, and 331f;

three power storage modules (not shown) of electric energy storage device 10 correspond to three power storage modules (not shown) including power storage module 331g; and

three power storage modules (not shown) of electric energy storage device 11 correspond to three power storage modules (not shown).

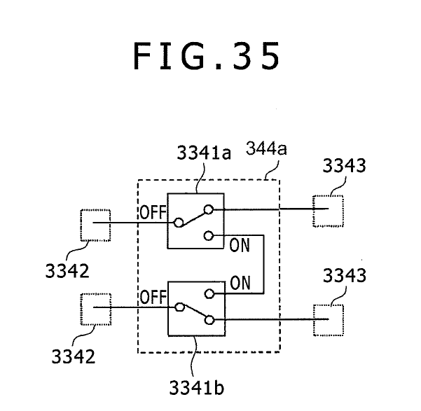

FIG. 34 shows a hardware configuration when bypass circuits are added to the actual hardware configuration of the battery energy storage system 1 shown in FIG. 33. FIG. 35 shows a circuit configuration of a bypass circuit.

In the battery energy storage system 1 shown in FIG. 34, bypass circuits 344a to 344d are provided so as to correspond to the power converters 333a to 333d. The bypass circuits 344a to 344d are provided so as to be separated from the corresponding power converters 333a to 333d, and are attached to the power converter attaching boards 332a and 332b so as to be aligned with the corresponding power converters 333a to 333d in a vertical direction.

As shown in FIG. 35, the bypass circuit 344a is a connection switching circuit including: a selector switch 3341a electrically connected between one of midpoint side terminals 3342 that is electrically connected to the midpoint of the first arm forming the switching circuit (see the full-bridge inverter circuit shown in FIG. 2) of the power converter 333a (point of electric connection between the source of the switching device 41a of the upper arm and the drain of the switching device 41b of the lower arm) and one of alternating-current terminals 3343; and a selector switch 3341b electrically connected between the other of the midpoint side terminals 3342 that is electrically connected to the midpoint of the second arm (point of electric connection between the source of the switching device 41c of the upper arm and the drain of the switching device 41d of the lower arm) and the other of the alternating-current terminals 3343; wherein when the selector switches 3341a and 3341b are off, the bypass circuit 344a electrically connects one of the midpoint side terminals 3342 to one of the alternating-current terminals 3343, and electrically connects the other of the midpoint side terminals 3342 to the other of the alternating-current terminals 3343, and when the selector switches 3341a and 3341b are on, the bypass circuit 344a interrupts the electric connection of one of the midpoint side terminals 3342 to one of the alternating-current terminals 3343 and the electric connection of the other of the midpoint side terminals 3342 to the other of the alternating-current terminals 3343, and electrically connects one and the other of the alternating-current terminals 3343 so as to bypass the power converter 333a.

Incidentally, the bypass circuits 344b, 344c, and 344d are configured in a similar manner to the bypass circuit 344a.

Thus, the bypass circuits 344a to 344d are provided, and the selector switches 3341a and 3341b are turned on to electrically disconnect the alternating-current terminals 3343 from the midpoint side terminals 3342, and electrically connect one and the other of the alternating-current terminals 3343 so as to bypass the power converter 333a. Thereby the power converters 333a to 333d can be electrically disconnected from the electric series circuit from one of the load side connection terminals of the battery energy storage system 1 to the other without the electric series circuit from one of the load side connection terminals of the storage system 1 to the other being disconnected at a midpoint. Therefore the power converters 333a to 333d can be replaced during the operation of the storage system 1.

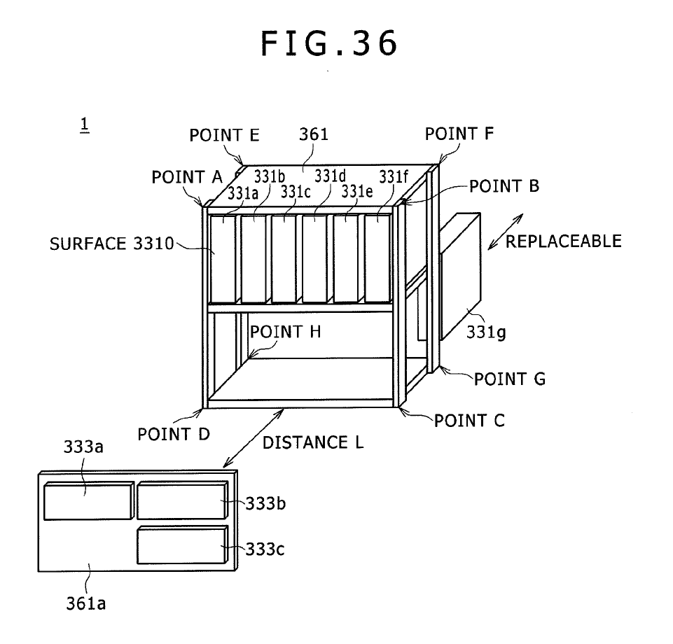

FIG. 36 shows a hardware configuration when a part of the actual hardware configuration of the battery energy storage system 1 shown in FIG. 33 is changed.

The battery energy storage system 1 shown in FIG. 36 includes an installation stand 361 formed by removing the power converter attaching boards 332a and 332b from the installation stand 332 shown in FIG. 33 and an installation stand 361a. As in the case of FIG. 33, a plurality of power storage modules including the power storage modules 331a to 331g are mounted in the installation stand 361. A plurality of power converters including the power converters 333a to 333c are attached to the installation stand 361a so as to be arranged on an upper and a lower side and a left and a right side. The interval of a distance L is provided between the installation stand 361 and the installation stand 361a. However, the interval may not be provided.

The battery energy storage system 1 shown in FIG. 36 can also achieve effect and action similar to those of the storage system 1 shown in FIG. 33.

FIG. 37 shows a hardware configuration when the battery energy storage system 1 shown in FIG. 34 is configured in a similar manner to the storage system 1 shown in FIG. 36.

In the battery energy storage system 1 shown in FIG. 37, as shown in FIG. 36, the power converters 333a to 333d are attached to the installation stand 361a as shown in FIG. 36, and the bypass circuits 344a to 344d shown in FIG. 34 are also attached to the installation stand 361a. The bypass circuits 344a to 344d are provided so as to be separated from the corresponding power converters 333a to 333d, and are attached to the installation stand 361a so as to be aligned with the corresponding power converters 333a to 333d in a vertical direction.

Also in the battery energy storage system 1 shown in FIG. 37, as shown in FIG. 34, the bypass circuits 344a to 344d are operated, whereby the corresponding power converters 333a to 333d can be electrically disconnected from the electric series circuit from one of the load side connection terminals of the storage system 1 to the other without the electric series circuit from one of the load side connection terminals of the storage system 1 to the other being disconnected at a midpoint. Therefore the corresponding power converters 333a to 333d can be replaced during the operation of the storage system 1. In addition, the bypass circuits 344a to 344d are provided so as to be separated from the corresponding power converters 333a to 333d. It is thus possible to remove only the power converters 333a to 333d without involving the removal of the bypass circuits 344a to 344d, and replace the power converters 333a to 333d. Therefore the work of removing the power converters 333a to 333d can be performed easily.

The present invention is not limited to the contents of the foregoing embodiment. Other modes conceivable within the scope of the technical concept of the present invention are also included in the scope of the present invention.

The content disclosed in the following application, upon which priority is claimed, is incorporated herein by reference:
Japanese Patent Application 2011-123028 (filed on Jun. 1, 2011)

1-2. (canceled)

3. The battery energy storage system comprising:
a power control circuit group formed by electrically connecting a plurality of power control circuits in series with each other on a load connection terminal side, the plurality of power control circuits each having load connection terminals electrically connected with a load and having power supply connection terminals electrically connected with a power supply, the power control circuits controlling power supplied to the load side connection terminals or the power supply side connection terminals to output the power from the power supply side connection terminals or the load side connection terminals;
an electric energy storage device including a plurality of capacitors, the electric energy storage device being provided so as to correspond to each of the plurality of power control circuits and electrically connected as the power supply to the power supply connection terminals of the corresponding power control circuit; a control device for controlling operation of the plurality of power control circuits; and
power usage rate changing section provided to correspond to each of the power control circuits for changing the ratio of a power usage rate of the corresponding power control circuit, where the power usage rate is defined as a ratio of an amount of power that each of the power control circuits contributes to an amount of input-output power of the power control circuit group in a predetermined period to a total amount of power in the predetermined period, the total amount of power in the predetermined period being transferred between the load connection terminals and the power supply connection terminals of the plurality of power control circuits;
wherein when the ratio of the power usage rate of the corresponding power control circuit needs to be changed, the power usage rate changing section makes the absolute value of the ratio of the power usage rate of the corresponding power control circuit smaller than before the changing is performed, with zero set as a target.

4. The battery energy storage system according to claim 3,
wherein the power usage rate changing section decreases the absolute value of the ratio of the power usage rate of the corresponding power control circuit by decreasing an average value of the power of the corresponding power control circuit in a period of one cycle of an alternating voltage waveform, the power of the corresponding power control circuit being on the load connection terminal side, or voltage of the corresponding power control circuit, the voltage of the corresponding power control circuit being on the load connection terminal side.

5. The battery energy storage system according to claim 3,
wherein the power usage rate changing section changes the absolute value of the ratio of the power usage rate of the corresponding power control circuit when a storage battery of the electric energy storage device electrically connected to the corresponding power control circuit needs to be replaced.

6. The battery energy storage system according to claim 3, further comprising a signal device for transmitting a command signal to the power usage rate changing section according to a mechanical operation,
wherein the power usage rate changing section receives the command signal from the signal device or a command signal from an external device as a trigger, and changes the absolute value of the ratio of the power usage rate of the corresponding power control circuit.

7. The battery energy storage system according to claim 3,
wherein each electric energy storage device includes
a plurality of power storage modules electrically connected in parallel with each other and each including a plurality of capacitors, and
a switch provided for each of the plurality of power storage modules to disconnect the corresponding power storage module from the electric parallel connection.

8. The battery energy storage system according to claim 7,
wherein when a capacitor in a power storage module among the plurality of power storage modules needs to be replaced, the absolute value of the power usage rate of the power converter corresponding to the electric energy storage device formed by the power storage module including the capacitor that needs to be replaced is decreased, and the power storage module including the capacitor that needs to be replaced is disconnected from the electric parallel connection by the switch.

9. The battery energy storage system according to claim 7,
wherein when there is an empty power storage module from which the plurality of capacitors are removed and the empty power storage module is disconnected from the electric parallel connection by the switch, and a capacitor of a power storage module electrically connected to the electric parallel connection by the switch needs to be replaced, a capacitor or a plurality of capacitors are attached to the empty power storage module, the absolute value of the power usage rate of the power converter corresponding to the electric energy storage device of the power storage module including the capacitor that needs to be replaced is decreased in a state in which the power storage module to which the capacitor or the plurality of capacitors are attached is electrically connected to the electric parallel connection by the switch, and the power storage module including the capacitor that needs to be replaced is disconnected from the electric parallel connection by the switch.

10. The battery energy storage system according to claim 7, further comprising an installation stand,
wherein the plurality of power storage modules are inserted into the installation stand from one direction, and are juxtaposed with each other in a direction orthogonal to the direction of insertion.

11. The battery energy storage system according to claim 3,
wherein bypass circuits including bypass switches are provided between the power control circuits and the load side connection terminals, and
when the bypass switches are turned on, the bypass circuits bypass the power control circuits and establish electric connection between the load side connection terminals.
